(19) United States
(12) Patent Application Publication
(10) Pub. No.: US 2022/0217697 A1
(43) Pub. Date: Jul. 7, 2022

(54) INFORMATION RELATING TO RESOURCE FOR SIDELINK TRANSMISSION

(71) Applicant: LG ELECTRONICS INC., Seoul (KR)

(72) Inventors: Seungmin LEE, Seoul (KR); Hanbyul SEO, Seoul (KR)

(21) Appl. No.: 17/608,419

(22) PCT Filed: May 4, 2020
(86) PCT No.: PCT/KR2020/005919

§ 371 Date: Nov. 2, 2021

Related U.S. Application Data
(60) Provisional application No. 62/843,334, filed on May 3, 2019.

(51) Int. Cl. H04W 72/04

(52) U.S. Cl. CPC H04W 72/0406

(57) ABSTRACT

According to an embodiment of the present disclosure, a method of performing SL communication by a first device is provided. The method may comprise the steps of: transmitting information related to a first resource for initial transmission of the first device to a second device; and performing the initial transmission with respect to a third device on the first resource, wherein the information related to the first resource is transmitted, to the second device, on a second resource preceding the first resource in time.

### BACKGROUND OF THE DISCLOSURE

### Field of the Disclosure

This disclosure relates to a wireless communication system.

### Related Art

Sidelink (SL) communication is a communication scheme in which a direct link is established between User Equipments (UEs) and the UEs exchange voice and data directly with each other without intervention of an evolved Node B (eNB). SL communication is under consideration as a solution to the overhead of an eNB caused by rapidly increasing data traffic.

Vehicle-to-everything (V2X) refers to a communication technology through which a vehicle exchanges information with another vehicle, a pedestrian, an object having an infrastructure (or infra) established therein, and so on. The V2X may be divided into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

Meanwhile, as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. And, a next generation radio access technology that is based on the enhanced mobile broadband communication, massive Machine Type Communication (MTC), Ultra-Reliable and Low Latency Communication (URLLC), and so on, may be referred to as a new radio access technology (RAT) or new radio (NR). Herein, the NR may also support vehicle-to-everything (V2X) communication.

FIG. 1 is a drawing for describing V2X communication based on NR, compared to V2X communication based on RAT used before NR. The embodiment of FIG. 1 may be combined with various embodiments of the present disclosure.

Regarding V2X communication, a scheme of providing a safety service, based on a V2X message such as Basic Safety Message (BSM), Cooperative Awareness Message (CAM), and Decentralized Environmental Notification Message (DENM) is focused in the discussion on the RAT used before the NR. The V2X message may include position information, dynamic information, attribute information, or the like. For example, a UE may transmit a periodic message type CAM and/or an event triggered message type DENM to another UE.

For example, the CAM may include dynamic state information of the vehicle such as direction and speed, static data of the vehicle such as a size, and basic vehicle information such as an exterior illumination state, route details, or the like. For example, the UE may broadcast the CAM, and latency of the CAM may be less than 100 ms. For example, the UE may generate the DENM and transmit it to another UE in an unexpected situation such as a vehicle breakdown, accident, or the like. For example, all vehicles within a transmission range of the UE may receive the CAM and/or the DENM. In this case, the DENM may have a higher priority than the CAM.

Thereafter, regarding V2X communication, various V2X scenarios are proposed in NR. For example, the various V2X scenarios may include vehicle platooning, advanced driving, extended sensors, remote driving, or the like.

For example, based on the vehicle platooning, vehicles may move together by dynamically forming a group. For example, in order to perform platoon operations based on the vehicle platooning, the vehicles belonging to the group may receive periodic data from a leading vehicle. For example, the vehicles belonging to the group may decrease or increase an interval between the vehicles by using the periodic data.

For example, based on the advanced driving, the vehicle may be semi-automated or fully automated. For example, each vehicle may adjust trajectories or maneuvers, based on data obtained from a local sensor of a proximity vehicle and/or a proximity logical entity. In addition, for example, each vehicle may share driving intention with proximity vehicles.

For example, based on the extended sensors, raw data, processed data, or live video data obtained through the local sensors may be exchanged between a vehicle, a logical entity, a UE of pedestrians, and/or a V2X application server. Therefore, for example, the vehicle may recognize a more improved environment than an environment in which a self-sensor is used for detection.

For example, based on the remote driving, for a person who cannot drive or a remote vehicle in a dangerous environment, a remote driver or a V2X application may operate or control the remote vehicle. For example, if a route is predictable such as public transportation, cloud computing based driving may be used for the operation or control of the remote vehicle. In addition, for example, an access for a cloud-based back-end service platform may be considered for the remote driving.

Meanwhile, a scheme of specifying service requirements for various V2X scenarios such as vehicle platooning, advanced driving, extended sensors, remote driving, or the like is discussed in NR-based V2X communication.

### SUMMARY OF THE DISCLOSURE

### Technical Objects

An object of the present disclosure is to provide a sidelink (SL) communication method between apparatuses (or UEs) and an apparatus (or UE) for performing the same.

Another technical object of the present disclosure is to provide a method for transmitting information on resources for sidelink transmission and an apparatus (or UE) for performing the same.

### Technical Solutions

According to an embodiment of the present disclosure, a method for a first apparatus to perform sidelink (SL) communication may be provided. The method may include transmitting information related to a first resource for initial transmission of the first apparatus to a second apparatus and performing the initial transmission to a third apparatus on the first resource, wherein information related to the first resource may be transmitted to the second apparatus on a second resource that precedes the first resource in time.

According to an embodiment of the present disclosure, a first apparatus for performing sidelink (SL) communication may be proposed. The first apparatus may comprise: one or more memories storing instructions; one or more transceivers; and one or more processors connected to the one or more memories and the one or more transceivers, wherein the one or more processors execute the instructions to: control the one or more transceivers to transmit information related to a first resource for initial transmission of the first apparatus to a second apparatus; and control the one or more transceivers to perform the initial transmission to a third apparatus on the first resource, wherein the information related to the first resource is transmitted to the second apparatus on a second resource that precedes the first resource in time.

According to an embodiment of the present disclosure, an apparatus (or chip(set)) configured to control a first user equipment (UE) may be proposed. The apparatus may comprise: one or more processors; and one or more memories operably connectable to the one or more processors and storing instructions, wherein the one or more processors execute the instructions to: transmit information related to a first resource for initial transmission of a first UE to a second UE; and perform the initial transmission to a third UE on the first resource, wherein the information related to the first resource is transmitted to the second UE on a second resource that precedes the first resource in time.

According to an embodiment of the present disclosure, a non-transitory computer-readable storage medium storing instructions (or indications) may be proposed. The instructions, when executed, may cause a first apparatus to: transmit information related to a first resource for initial transmission of the first apparatus to a second apparatus; and perform the initial transmission to a third apparatus on the first resource, wherein the information related to the first resource is transmitted to the second apparatus on a second resource that precedes the first resource in time.

According to an embodiment of the present disclosure, a method for performing, by a second apparatus, sidelink (SL) communication may be proposed. The method may comprise: transmitting information related to a first resource for initial transmission of the first apparatus to a second apparatus; and performing the initial transmission to a third apparatus on the first resource, wherein the information related to the first resource is transmitted to the second apparatus on a second resource that precedes the first resource in time.

According to an embodiment of the present disclosure, a second apparatus for performing sidelink (SL) communication may be proposed. The second apparatus may comprise: one or more memories storing instructions; one or more transceivers; and one or more processors connected to the one or more memories and the one or more transceivers, wherein the one or more processors execute the instructions to: control the one or more transceivers to receive information related to a first resource for initial transmission of a first apparatus, transmitted from the first apparatus; and perform SL communication based on the information related to the first resource, wherein the information related to the first resource is transmitted from the first apparatus on a second resource that precedes the first resource in time.

### Effects of the Disclosure

According to the present disclosure, sidelink communication between apparatuses (or UEs) can be efficiently performed.

According to the present disclosure, information related to a resource for initial transmission of a apparatus (or UE) can be efficiently transmitted to another apparatus.

### BRIEF DESCRIPTION OF THE DRAWINGS

FIG. 1 is a drawing for describing V2X communication based on NR, compared to V2X communication based on RAT used before NR.

FIG. 2 shows a structure of an NR system, based on an embodiment of the present disclosure.

FIG. 3 shows a functional division between an NG-RAN and a 5GC, based on an embodiment of the present disclosure.

FIGS. 4A and 4B show a radio protocol architecture, based on an embodiment of the present disclosure.

FIG. 5 shows a structure of an NR system, based on an embodiment of the present disclosure.

FIG. 6 shows a structure of a slot of an NR frame, based on an embodiment of the present disclosure.

FIG. 7 shows an example of a BWP, based on an embodiment of the present disclosure.

FIGS. 8A and 8B show a radio protocol architecture for a SL communication, based on an embodiment of the present disclosure.

FIG. 9 shows a UE performing V2X or SL communication, based on an embodiment of the present disclosure.

FIGS. 10A and 10B show a procedure of performing V2X or SL communication by a UE based on a transmission mode, based on an embodiment of the present disclosure.

FIGS. 11A to 11C show three cast types, based on an embodiment of the present disclosure.

FIG. 12 shows an example in which sidelink communication is performed between apparatuses based on information related to resources for initial transmission.

FIG. 13 shows another example in which sidelink communication is performed between apparatuses based on information related to resources for initial transmission.

FIG. 14 is a flowchart showing an operation of a first apparatus according to an embodiment of the present disclosure.

FIG. 15 is a flowchart showing an operation of a second apparatus according to an embodiment of the present disclosure.

FIG. 16 shows a communication system 1, based on an embodiment of the present disclosure.

FIG. 17 shows wireless devices, based on an embodiment of the present disclosure.

FIG. 18 shows a signal process circuit for a transmission signal, based on an embodiment of the present disclosure.

FIG. 19 shows another example of a wireless device, based on an embodiment of the present disclosure.

FIG. 20 shows a hand-held device, based on an embodiment of the present disclosure.

FIG. 21 shows a vehicle or an autonomous vehicle, based on an embodiment of the present disclosure.

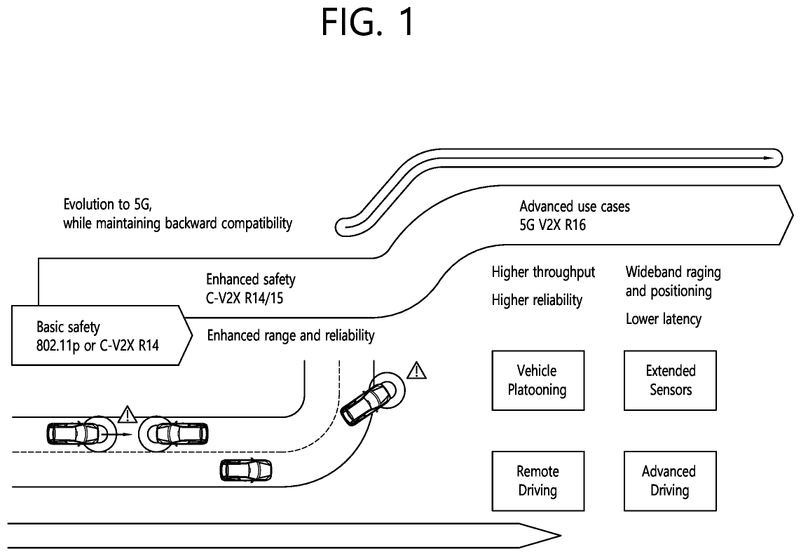

### DESCRIPTION OF EXEMPLARY EMBODIMENTS

In the present disclosure, “A or B” may mean “only A”, “only B” or “both A and B.” In other words, in the present disclosure, “A or B” may be interpreted as “A and/or B”. For example, in the present disclosure, “A, B, or C” may mean “only A”, “only B”, “only C”, or “any combination of A, B, C”.

A slash (/) or comma used in the present disclosure may mean “and/or”. For example, “A/B” may mean “A and/or B”. Accordingly, “A/B” may mean “only A”, “only B”, or “both A and B”. For example, “A, B, C” may mean “A, B, or C”.

In the present disclosure, “at least one of A and B” may mean “only A”, “only B”, or “both A and B”. In addition, in the present disclosure, the expression “at least one of A or B” or “at least one of A and/or B” may be interpreted as “at least one of A and B”.

In addition, in the present disclosure, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present disclosure may mean “for example”. Specifically, when indicated as “control information (PDCCH)”, it may mean that “PDCCH” is proposed as an example of the “control information”. In other words, the “control information” of the present disclosure is not limited to “PDCCH”, and “PDDCH” may be proposed as an example of the “control information”. In addition, when indicated as “control information (i.e., PDCCH)”, it may also mean that “PDCCH” is proposed as an example of the “control information”.

A technical feature described individually in one figure in the present disclosure may be individually implemented, or may be simultaneously implemented.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), and so on. IEEE 802.16m is an evolved version of IEEE 802.16e and provides backward compatibility with a system based on the IEEE 802.16e. The UTRA is part of a universal mobile telecommunication system (UMTS). 3rd generation partnership project (3GPP) long term evolution (LTE) is part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

5G NR is a successive technology of LTE-A corresponding to a new Clean-slate type mobile communication system having the characteristics of high performance, low latency, high availability, and so on. 5G NR may use resources of all spectrum available for usage including low frequency bands of less than 1 GHz, middle frequency bands ranging from 1 GHz to 10 GHz, high frequency (millimeter waves) of 24 GHz or more, and so on.

For clarity in the description, the following description will mostly focus on LTE-A or 5G NR. However, technical features according to an embodiment of the present disclosure will not be limited only to this.

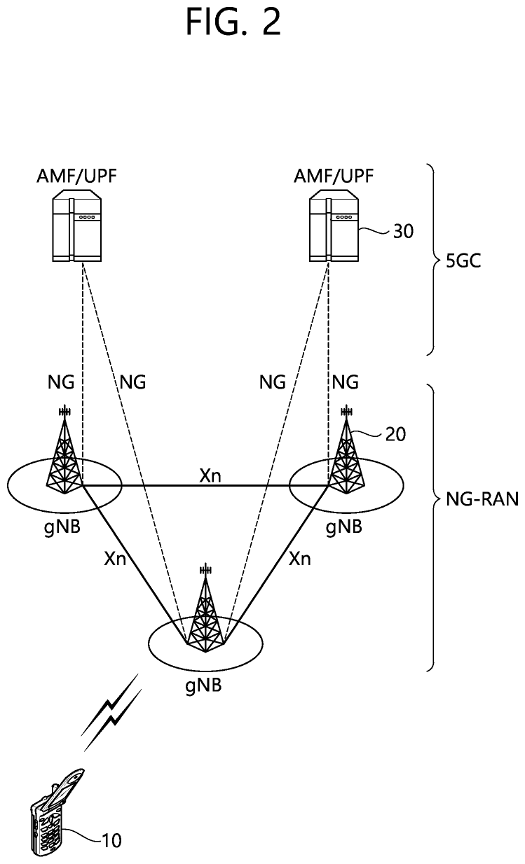

FIG. 2 shows a structure of an NR system, based on an embodiment of the present disclosure. The embodiment of FIG. 2 may be combined with various embodiments of the present disclosure.

Referring to FIG. 2, a next generation-radio access network (NG-RAN) may include a BS 20 providing a UE 10 with a user plane and control plane protocol termination. For example, the BS 20 may include a next generation-Node B (gNB) and/or an evolved-NodeB (eNB). For example, the UE 10 may be fixed or mobile and may be referred to as other terms, such as a mobile station (MS), a user terminal (UT), a subscriber station (SS), a mobile terminal (MT), wireless device, and so on. For example, the BS may be referred to as a fixed station which communicates with the UE 10 and may be referred to as other terms, such as a base transceiver system (BTS), an access point (AP), and so on.

The embodiment of FIG. 2 exemplifies a case where only the gNB is included. The BSs 20 may be connected to one another via Xn interface. The BS 20 may be connected to one another via 5th generation (5G) core network (5GC) and NG interface. More specifically, the BSs 20 may be connected to an access and mobility management function (AMF) 30 via NG-C interface, and may be connected to a user plane function (UPF) 30 via NG-U interface.

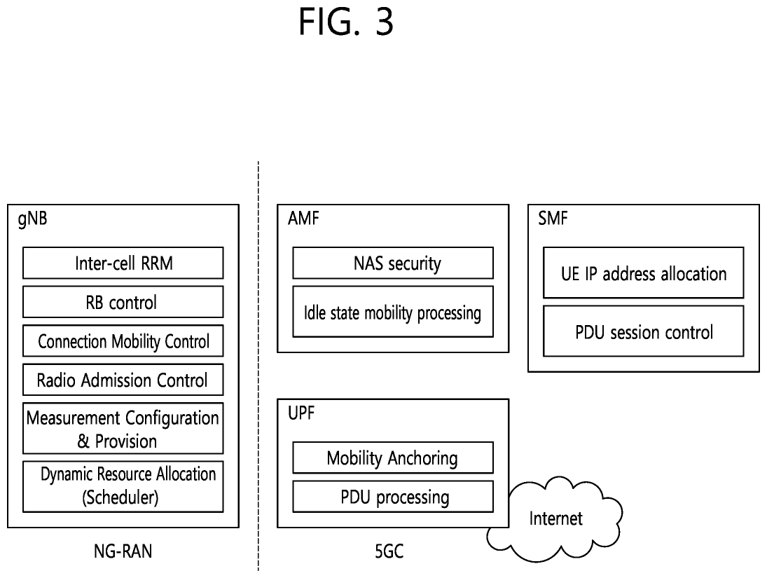

FIG. 3 shows a functional division between an NG-RAN and a 5GC, based on an embodiment of the present disclosure. The embodiment of FIG. 3 may be combined with various embodiments of the present disclosure.

Referring to FIG. 3, the gNB may provide functions, such as Inter Cell Radio Resource Management (RRM), Radio Bearer (RB) control, Connection Mobility Control, Radio Admission Control, Measurement Configuration & Provision, Dynamic Resource Allocation, and so on. An AMF may provide functions, such as Non Access Stratum (NAS) security, idle state mobility processing, and so on. A UPF may provide functions, such as Mobility Anchoring, Protocol Data Unit (PDU) processing, and so on. A Session Management Function (SMF) may provide functions, such as user equipment (UE) Internet Protocol (IP) address allocation, PDU session control, and so on.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

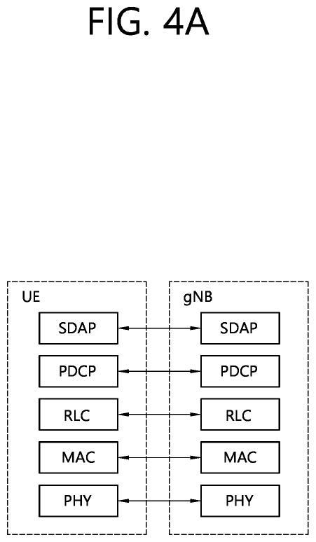

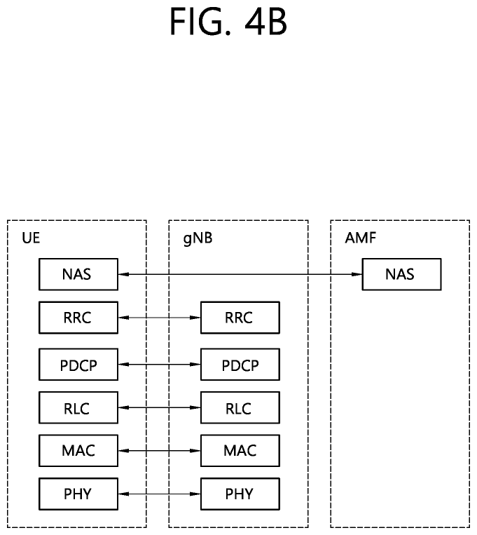

FIGS. 4A and 4B show a radio protocol architecture, based on an embodiment of the present disclosure. The embodiment of FIGS. 4A and 4B may be combined with various embodiments of the present disclosure. Specifically, FIG. 4A shows a radio protocol architecture for a user plane, and FIG. 4B shows a radio protocol architecture for a control plane. The user plane corresponds to a protocol stack for user data transmission, and the control plane corresponds to a protocol stack for control signal transmission.

Referring to FIGS. 4A and 4B, a physical layer provides an upper layer with an information transfer service through a physical channel. The physical layer is connected to a medium access control (MAC) layer which is an upper layer of the physical layer through a transport channel. Data is transferred between the MAC layer and the physical layer through the transport channel. The transport channel is classified according to how and with what characteristics data is transmitted through a radio interface.

Between different physical layers, i.e., a physical layer of a transmitter and a physical layer of a receiver, data are transferred through the physical channel. The physical channel is modulated using an orthogonal frequency division multiplexing (OFDM) scheme, and utilizes time and frequency as a radio resource.

The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. The MAC layer provides data transfer services over logical channels.

The RLC layer performs concatenation, segmentation, and reassembly of Radio Link Control Service Data Unit (RLC SDU). In order to ensure diverse quality of service (QoS) required by a radio bearer (RB), the RLC layer provides three types of operation modes, i.e., a transparent mode (TM), an unacknowledged mode (UM), and an acknowledged mode (AM). An AM RLC provides error correction through an automatic repeat request (ARQ).

A radio resource control (RRC) layer is defined only in the control plane. The RRC layer serves to control the logical channel, the transport channel, and the physical channel in association with configuration, reconfiguration and release of RBs. The RB is a logical path provided by the first layer (i.e., the physical layer or the PHY layer) and the second layer (i.e., the MAC layer, the RLC layer, and the packet data convergence protocol (PDCP) layer) for data delivery between the UE and the network.

Functions of a packet data convergence protocol (PDCP) layer in the user plane include user data delivery, header compression, and ciphering. Functions of a PDCP layer in the control plane include control-plane data delivery and ciphering/integrity protection.

A service data adaptation protocol (SDAP) layer is defined only in a user plane. The SDAP layer performs mapping between a Quality of Service (QoS) flow and a data radio bearer (DRB) and QoS flow ID (QFI) marking in both DL and UL packets.

The configuration of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the E-UTRAN, the UE is in an RRC_CONNECTED state, and, otherwise, the UE may be in an RRC_IDLE state. In case of the NR, an RRC_INACTIVE state is additionally defined, and a UE being in the RRC_INACTIVE state may maintain its connection with a core network whereas its connection with the BS is released.

Data is transmitted from the network to the UE through a downlink transport channel. Examples of the downlink transport channel include a broadcast channel (BCH) for transmitting system information and a downlink-shared channel (SCH) for transmitting user traffic or control messages. Traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

The physical channel includes several OFDM symbols in a time domain and several sub-carriers in a frequency domain. One sub-frame includes a plurality of OFDM symbols in the time domain. A resource block is a unit of resource allocation, and consists of a plurality of OFDM symbols and a plurality of sub-carriers. Further, each subframe may use specific sub-carriers of specific OFDM symbols (e.g., a first OFDM symbol) of a corresponding subframe for a physical downlink control channel (PDCCH), i.e., an L1/L2 control channel. A transmission time interval (TTI) is a unit time of subframe transmission.

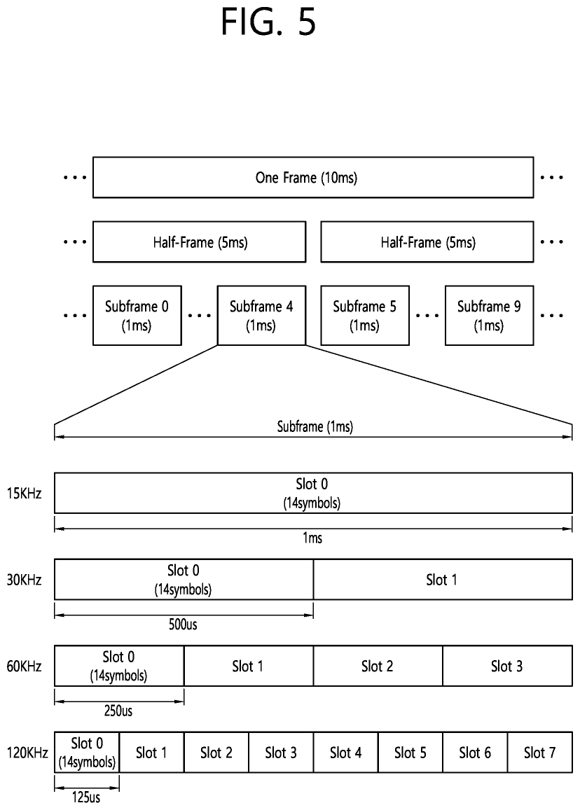

FIG. 5 shows a structure of an NR system, based on an embodiment of the present disclosure. The embodiment of FIG. 5 may be combined with various embodiments of the present disclosure.

Referring to FIG. 5, in the NR, a radio frame may be used for performing uplink and downlink transmission. A radio frame has a length of 10 ms and may be defined to be configured of two half-frames (HFs). A half-frame may include five 1 ms subframes (SFs). A subframe (SF) may be divided into one or more slots, and the number of slots within a subframe may be determined based on subcarrier spacing (SCS). Each slot may include 12 or 14 OFDM(A) symbols according to a cyclic prefix (CP).

In case of using a normal CP, each slot may include 14 symbols. In case of using an extended CP, each slot may include 12 symbols. Herein, a symbol may include an OFDM symbol (or CP-OFDM symbol) and a Single Carrier-FDMA (SC-FDMA) symbol (or Discrete Fourier Transform-spread-OFDM (DFT-s-OFDM) symbol).

Table 1 shown below represents an example of a number of symbols per slot (Nslotsymb), a number slots per frame (Nframe,uslot), and a number of slots per subframe (Nsubframe,uslot) based on an SCS configuration (u), in a case where a normal CP is used.

TABLE 1

| | | | |
|---|---|---|---|
| SCS (15*2^{u}) | N^{slot}_{symb} | N^{frame, u}ₛₗₒₜ | N^{subframe, u}ₛₗₒₜ |

| | | | | |
|---|---|---|---|---|
| 15 | KHz (u = 0) | 14 | 10 | 1 |
| 30 | KHz (u = 1) | 14 | 20 | 2 |
| 60 | KHz (u = 2) | 14 | 40 | 4 |
| 120 | KHz (u = 3) | 14 | 80 | 8 |
| 240 | KHz (u = 4) | 14 | 160 | 16 |

Table 2 shows an example of a number of symbols per slot, a number of slots per frame, and a number of slots per subframe based on the SCS, in a case where an extended CP is used.

TABLE 2

| SCS (15*2^{u}) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In an NR system, OFDM(A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells.

In the NR, multiple numerologies or SCSs for supporting diverse 5G services may be supported. For example, in case an SCS is 15 kHz, a wide area of the conventional cellular bands may be supported, and, in case an SCS is 30 kHz/60 kHz a dense-urban, lower latency, wider carrier bandwidth may be supported. In case the SCS is 60 kHz or higher, a bandwidth that is greater than 24.25 GHz may be used in order to overcome phase noise.

An NR frequency band may be defined as two different types of frequency ranges. The two different types of frequency ranges may be FR1 and FR2. The values of the frequency ranges may be changed (or varied), and, for example, the two different types of frequency ranges may be as shown below in Table 3. Among the frequency ranges that are used in an NR system, FR1 may mean a “sub 6 GHz range”, and FR2 may mean an “above 6 GHz range” and may also be referred to as a millimeter wave (mmW).

TABLE 3

| Frequency Range | Corresponding frequency | |
|---|---|---|
| designation | range | Subcarrier Spacing (SCS) |
| FR1 | 450 MHz-6000 MHz | 15, 30, 60 kHz |
| FR2 | 24250 MHz-52600 MHz | 60, 120, 240 kHz |

As described above, the values of the frequency ranges in the NR system may be changed (or varied). For example, as shown below in Table 4, FR1 may include a band within a range of 410 MHz to 7125 MHz. More specifically, FR1 may include a frequency band of 6 GHz (or 5850, 5900, 5925 MHz, and so on) and higher. For example, a frequency band of 6 GHz (or 5850, 5900, 5925 MHz, and so on) and higher being included in FR1 mat include an unlicensed band. The unlicensed band may be used for diverse purposes, e.g., the unlicensed band for vehicle-specific communication (e.g., automated driving).

TABLE 4

| Frequency Range | Corresponding frequency | |
|---|---|---|
| designation | range | Subcarrier Spacing (SCS) |
| FR1 | 410 MHz-7125 MHz | 15, 30, 60 kHz |
| FR2 | 24250 MHz-52600 MHz | 60, 120, 240 kHz |

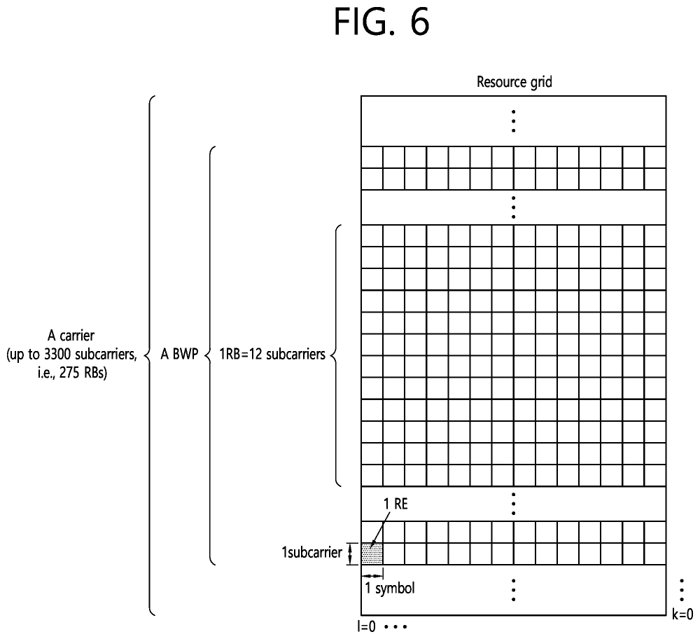

FIG. 6 shows a structure of a slot of an NR frame, based on an embodiment of the present disclosure. The embodiment of FIG. 6 may be combined with various embodiments of the present disclosure.

Referring to FIG. 6, a slot includes a plurality of symbols in a time domain. For example, in case of a normal CP, one slot may include 14 symbols. However, in case of an extended CP, one slot may include 12 symbols. Alternatively, in case of a normal CP, one slot may include 7 symbols. However, in case of an extended CP, one slot may include 6 symbols.

A carrier includes a plurality of subcarriers in a frequency domain. A Resource Block (RB) may be defined as a plurality of consecutive subcarriers (e.g., 12 subcarriers) in the frequency domain. A Bandwidth Part (BWP) may be defined as a plurality of consecutive (Physical) Resource Blocks ((P)RBs) in the frequency domain, and the BWP may correspond to one numerology (e.g., SCS, CP length, and so on). A carrier may include a maximum of N number BWPs (e.g., 5 BWPs). Data communication may be performed via an activated BWP. Each element may be referred to as a Resource Element (RE) within a resource grid and one complex symbol may be mapped to each element.

Meanwhile, a radio interface between a UE and another UE or a radio interface between the UE and a network may consist of an L1 layer, an L2 layer, and an L3 layer. In various embodiments of the present disclosure, the L1 layer may imply a physical layer. In addition, for example, the L2 layer may imply at least one of a MAC layer, an RLC layer, a PDCP layer, and an SDAP layer. In addition, for example, the L3 layer may imply an RRC layer.

Hereinafter, a bandwidth part (BWP) and a carrier will be described.

The BWP may be a set of consecutive physical resource blocks (PRBs) in a given numerology. The PRB may be selected from consecutive sub-sets of common resource blocks (CRBs) for the given numerology on a given carrier.

When using bandwidth adaptation (BA), a reception bandwidth and transmission bandwidth of a UE are not necessarily as large as a bandwidth of a cell, and the reception bandwidth and transmission bandwidth of the BS may be adjusted. For example, a network/BS may inform the UE of bandwidth adjustment. For example, the UE receive information/configuration for bandwidth adjustment from the network/BS. In this case, the UE may perform bandwidth adjustment based on the received information/configuration. For example, the bandwidth adjustment may include an increase/decrease of the bandwidth, a position change of the bandwidth, or a change in subcarrier spacing of the bandwidth.

For example, the bandwidth may be decreased during a period in which activity is low to save power. For example, the position of the bandwidth may move in a frequency domain. For example, the position of the bandwidth may move in the frequency domain to increase scheduling flexibility. For example, the subcarrier spacing of the bandwidth may be changed. For example, the subcarrier spacing of the bandwidth may be changed to allow a different service. A subset of a total cell bandwidth of a cell may be called a bandwidth part (BWP). The BA may be performed when the BS/network configures the BWP to the UE and the BS/network informs the UE of the BWP currently in an active state among the configured BWPs.

For example, the BWP may be at least any one of an active BWP, an initial BWP, and/or a default BWP. For example, the UE may not monitor downlink radio link quality in a DL BWP other than an active DL BWP on a primary cell (PCell). For example, the UE may not receive PDCCH, physical downlink shared channel (PDSCH), or channel state information-reference signal (CSI-RS) (excluding RRM) outside the active DL BWP. For example, the UE may not trigger a channel state information (CSI) report for the inactive DL BWP. For example, the UE may not transmit physical uplink control channel (PUCCH) or physical uplink shared channel (PUSCH) outside an active UL BWP. For example, in a downlink case, the initial BWP may be given as a consecutive RB set for a remaining minimum system information (RMSI) control resource set (CORESET) (configured by physical broadcast channel (PBCH)). For example, in an uplink case, the initial BWP may be given by system information block (SIB) for a random access procedure. For example, the default BWP may be configured by a higher layer. For example, an initial value of the default BWP may be an initial DL BWP. For energy saving, if the UE fails to detect downlink control information (DCI) during a specific period, the UE may switch the active BWP of the UE to the default BWP.

Meanwhile, the BWP may be defined for SL. The same SL BWP may be used in transmission and reception. For example, a transmitting UE may transmit an SL channel or an SL signal on a specific BWP, and a receiving UE may receive the SL channel or the SL signal on the specific BWP. In a licensed carrier, the SL BWP may be defined separately from a Uu BWP, and the SL BWP may have configuration signaling separate from the Uu BWP. For example, the UE may receive a configuration for the SL BWP from the BS/network. The SL BWP may be (pre-)configured in a carrier with respect to an out-of-coverage NR V2X UE and an RRC_IDLE UE. For the UE in the RRC_CONNECTED mode, at least one SL BWP may be activated in the carrier.

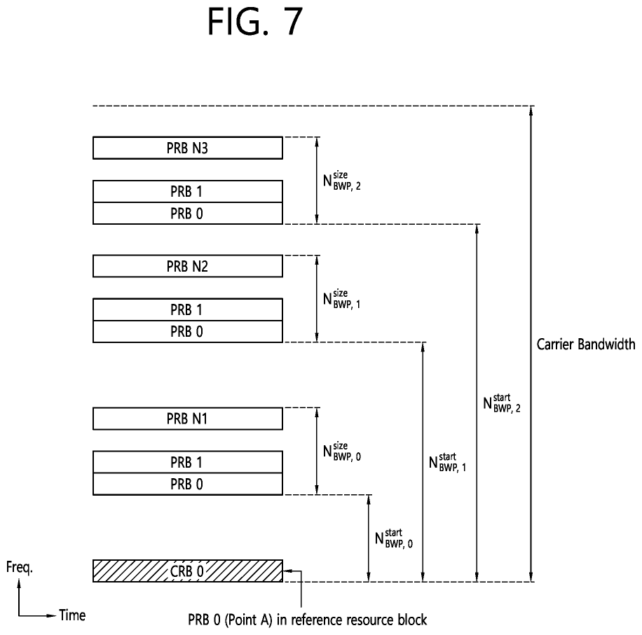

FIG. 7 shows an example of a BWP, based on an embodiment of the present disclosure. The embodiment of FIG. 7 may be combined with various embodiments of the present disclosure. It is assumed in the embodiment of FIG. 7 that the number of BWPs is 3.

Referring to FIG. 7, a common resource block (CRB) may be a carrier resource block numbered from one end of a carrier band to the other end thereof. In addition, the PRB may be a resource block numbered within each BWP. A point A may indicate a common reference point for a resource block grid.

The BWP may be configured by a point A, an offset NstartBWP from the point A, and a bandwidth NsizeBWP. For example, the point A may be an external reference point of a PRB of a carrier in which a subcarrier 0 of all numerologies (e.g., all numerologies supported by a network on that carrier) is aligned. For example, the offset may be a PRB interval between a lowest subcarrier and the point A in a given numerology. For example, the bandwidth may be the number of PRBs in the given numerology.

Hereinafter, V2X or SL communication will be described.

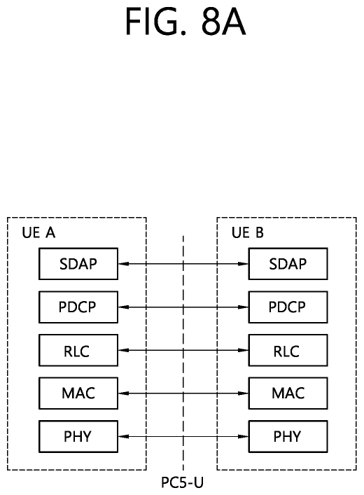

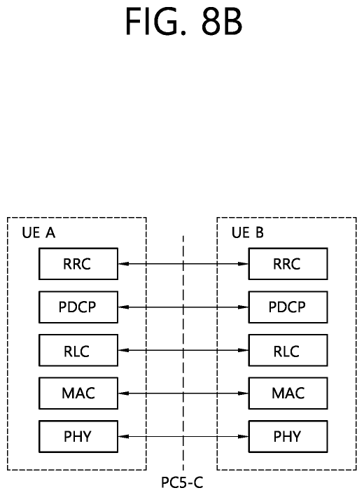

FIGS. 8A and 8B show a radio protocol architecture for a SL communication, based on an embodiment of the present disclosure. The embodiment of FIGS. 8A and 8B may be combined with various embodiments of the present disclosure. More specifically, FIG. 8A shows a user plane protocol stack, and FIG. 8B shows a control plane protocol stack.

Hereinafter, a sidelink synchronization signal (SLSS) and synchronization information will be described.

The SLSS may include a primary sidelink synchronization signal (PSSS) and a secondary sidelink synchronization signal (SSSS), as an SL-specific sequence. The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, a UE may use the S-PSS for initial signal detection and for synchronization acquisition. For example, the UE may use the S-PSS and the S-SSS for acquisition of detailed synchronization and for detection of a synchronization signal ID.

A physical sidelink broadcast channel (PSBCH) may be a (broadcast) channel for transmitting default (system) information which must be first known by the UE before SL signal transmission/reception. For example, the default information may be information related to SLSS, a duplex mode (DM), a time division duplex (TDD) uplink/downlink (UL/DL) configuration, information related to a resource pool, a type of an application related to the SLSS, a subframe offset, broadcast information, or the like. For example, for evaluation of PSBCH performance, in NR V2X, a payload size of the PSBCH may be 56 bits including 24-bit CRC.

The S-PSS, the S-SSS, and the PSBCH may be included in a block format (e.g., SL synchronization signal (SS)/PSBCH block, hereinafter, sidelink-synchronization signal block (S-SSB)) supporting periodical transmission. The S-SSB may have the same numerology (i.e., SCS and CP length) as a physical sidelink control channel (PSCCH)/physical sidelink shared channel (PSSCH) in a carrier, and a transmission bandwidth may exist within a (pre-)configured sidelink (SL) BWP. For example, the S-SSB may have a bandwidth of 11 resource blocks (RBs). For example, the PSBCH may exist across 11 RBs. In addition, a frequency position of the S-SSB may be (pre-)configured. Accordingly, the UE does not have to perform hypothesis detection at frequency to discover the S-SSB in the carrier.

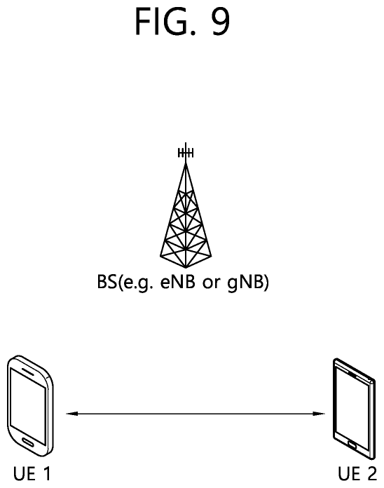

FIG. 9 shows a UE performing V2X or SL communication, based on an embodiment of the present disclosure. The embodiment of FIG. 9 may be combined with various embodiments of the present disclosure.

Referring to FIG. 9, in V2X or SL communication, the term ‘UE’ may generally imply a UE of a user. However, if a network equipment such as a BS transmits/receives a signal according to a communication scheme between UEs, the BS may also be regarded as a sort of the UE. For example, a UE 1 may be a first apparatus 100, and a UE 2 may be a second apparatus 200.

For example, the UE 1 may select a resource unit corresponding to a specific resource in a resource pool which implies a set of series of resources. In addition, the UE 1 may transmit an SL signal by using the resource unit. For example, a resource pool in which the UE 1 is capable of transmitting a signal may be configured to the UE 2 which is a receiving UE, and the signal of the UE 1 may be detected in the resource pool.

Herein, if the UE 1 is within a connectivity range of the BS, the BS may inform the UE 1 of the resource pool. Otherwise, if the UE 1 is out of the connectivity range of the BS, another UE may inform the UE 1 of the resource pool, or the UE 1 may use a pre-configured resource pool.

In general, the resource pool may be configured in unit of a plurality of resources, and each UE may select a unit of one or a plurality of resources to use it in SL signal transmission thereof.

Hereinafter, resource allocation in SL will be described.

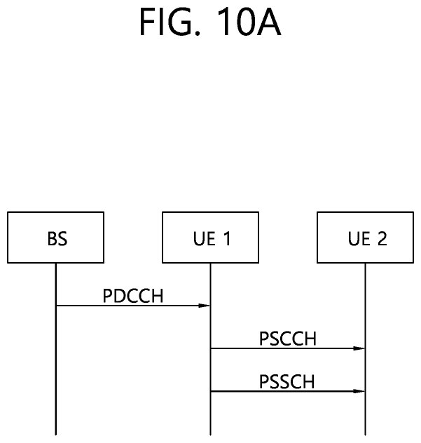

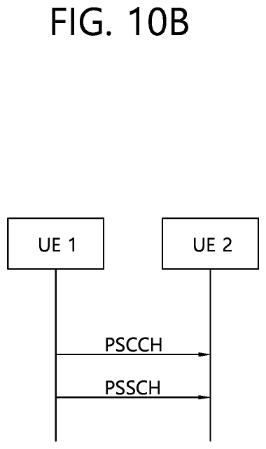

FIGS. 10A and 10B show a procedure of performing V2X or SL communication by a UE based on a transmission mode, based on an embodiment of the present disclosure. The embodiment of FIGS. 10A and 10B may be combined with various embodiments of the present disclosure. In various embodiments of the present disclosure, the transmission mode may be called a mode or a resource allocation mode. Hereinafter, for convenience of explanation, in LTE, the transmission mode may be called an LTE transmission mode. In NR, the transmission mode may be called an NR resource allocation mode.

For example, FIG. 10A shows a UE operation related to an LTE transmission mode 1 or an LTE transmission mode 3. Alternatively, for example, FIG. 10A shows a UE operation related to an NR resource allocation mode 1. For example, the LTE transmission mode 1 may be applied to general SL communication, and the LTE transmission mode 3 may be applied to V2X communication.

For example, FIG. 10B shows a UE operation related to an LTE transmission mode 2 or an LTE transmission mode 4. Alternatively, for example, FIG. 10B shows a UE operation related to an NR resource allocation mode 2.

Referring to FIG. 10A, in the LTE transmission mode 1, the LTE transmission mode 3, or the NR resource allocation mode 1, a BS may schedule an SL resource to be used by the UE for SL transmission. For example, the BS may perform resource scheduling to a UE 1 through a PDCCH (more specifically, downlink control information (DCI)), and the UE 1 may perform V2X or SL communication with respect to a UE 2 according to the resource scheduling. For example, the UE 1 may transmit a sidelink control information (SCI) to the UE 2 through a physical sidelink control channel (PSCCH), and thereafter transmit data based on the SCI to the UE 2 through a physical sidelink shared channel (PSSCH).

Referring to FIG. 10B, in the LTE transmission mode 2, the LTE transmission mode 4, or the NR resource allocation mode 2, the UE may determine an SL transmission resource within an SL resource configured by a BS/network or a pre-configured SL resource. For example, the configured SL resource or the pre-configured SL resource may be a resource pool. For example, the UE may autonomously select or schedule a resource for SL transmission. For example, the UE may perform SL communication by autonomously selecting a resource within a configured resource pool. For example, the UE may autonomously select a resource within a selective window by performing a sensing and resource (re)selection procedure. For example, the sensing may be performed in unit of subchannels. In addition, the UE 1 which has autonomously selected the resource within the resource pool may transmit the SCI to the UE 2 through a PSCCH, and thereafter may transmit data based on the SCI to the UE 2 through a PSSCH.

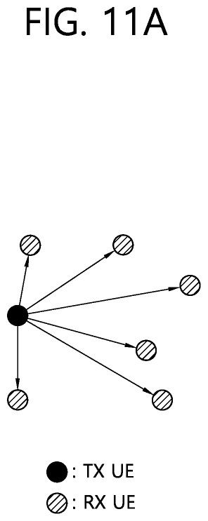

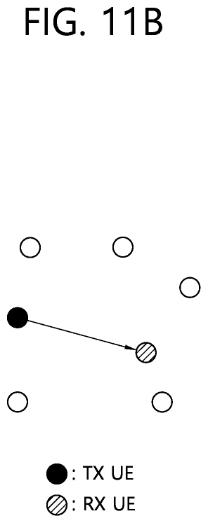

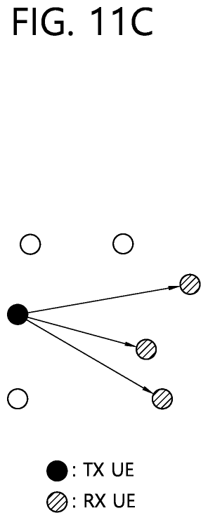

FIGS. 11A to 11C show three cast types, based on an embodiment of the present disclosure. The embodiment of FIGS. 11A to 11C may be combined with various embodiments of the present disclosure. Specifically, FIG. 11A shows broadcast-type SL communication, FIG. 11B shows unicast type-SL communication, and FIG. 11C shows groupcast-type SL communication. In case of the unicast-type SL communication, a UE may perform one-to-one communication with respect to another UE. In case of the groupcast-type SL transmission, the UE may perform SL communication with respect to one or more UEs in a group to which the UE belongs. In various embodiments of the present disclosure, SL groupcast communication may be replaced with SL multicast communication, SL one-to-many communication, or the like.

Meanwhile, in SL communication, a UE needs to efficiently select resource(s) for SL transmission. Hereinafter, based on various embodiments of the present disclosure, a method for a UE to efficiently select resource(s) for SL transmission and an apparatus supporting the same will be described. In various embodiments of the present disclosure, SL communication may include V2X communication.

At least one of the methods that are proposed based on the various embodiments of the present disclosure may be applied to at least one of unicast communication, groupcast communication, and/or broadcast communication.

At least one of the methods that are proposed based on the various embodiments of the present disclosure may be applied not only to PC5 interface or SL interface (e.g., PSCCH, PSSCH, PSBCH, PSSS/SSSS, and so on) based SL communication or V2X communication but also to Uu interface (e.g., PUSCH, PDSCH, PDCCH, PUCCH, and so on) based SL communication or V2X communication.

In the various embodiments of the present disclosure, receiving operation(s) (or action(s)) of the UE may include decoding operation(s) and/or receiving operation(s) of SL channel(s) and/or SL signal(s) (e.g., PSCCH, PSSCH, PSFCH, PSBCH, PSSS/SSSS, and so on). Receiving operation(s) of the UE may include decoding operation(s) and/or receiving operation(s) of WAN DL channel(s) and/or WAN DL signal(s) (e.g., PDCCH, PDSCH, PSS/SSS, and so on). Receiving operation(s) of the UE may include sensing operation(s) and/or channel busy ratio (CBR) measuring operation(s). In the various embodiments of the present disclosure, Sensing operation(s) of the UE may include PSSCH-RSRP measuring operation(s) based on PSSCH DM-RS sequence(s), PSSCH-RSRP measuring operation(s) based on PSSCH DM-RS sequence(s), which is scheduled by a PSCCH that is successfully decoded by the UE, sidelink RSSI (S-RSSI) measuring operation(s), and/or S-RSSI measuring operation(s) based on subchannel(s) related to V2X resource pool(s). In the various embodiments of the present disclosure, transmitting operation(s) of the UE may include transmitting operation(s) of SL channel(s) and/or SL signal(s) (e.g., PSCCH, PSSCH, PSFCH, PSBCH, PSSS/SSSS, and so on). Transmitting operation(s) may include transmitting operation(s) of WAN UL channel(s) and/or WAN UL signal(s) (e.g., PUSCH, PUCCH, SRS, and so on). In the various embodiments of the present disclosure, a synchronization signal may include an SLSS and/or a PSBCH.

In the various embodiments of the present disclosure, configuration may include signaling, signaling from a network, configuration from a network, and/or a pre-configuration from a network. In the various embodiments of the present disclosure, definition may include signaling, signaling from a network, configuration from a network, and/or a pre-configuration from a network. In the various embodiments of the present disclosure, designation may include signaling, signaling from a network, configuration from a network, and/or a pre-configuration from a network.

In the various embodiments of the present disclosure, ProSe Per Packet Priority (PPPP) may be replaced with ProSe Per Packet Reliability (PPPR), and PPPR may be replaced with PPPP. For example, as the PPPP value becomes smaller, this may indicate a high priority, and, as the PPPP value becomes greater, this may indicate a low priority. For example, as the PPPR value becomes smaller, this may indicate a high reliability, and, as the PPPR value becomes greater, this may indicate a low reliability. For example, a PPPP value related to a service, a packet or a message being related to a high priority may be smaller than a PPPP value related to a service, a packet or a message being related to a low priority. For example, a PPPR value related to a service, a packet or a message being related to a high reliability may be smaller than a PPPR value related to a service, a packet or a message being related to a low reliability.

In the various embodiments of the present disclosure, a session may include at least one of a unicast session (e.g., a unicast session for SL), a groupcast/multicast session (e.g., a groupcast/multicast session for SL), and/or a broadcast session (e.g., a broadcast session for SL).

In the various embodiments of the present disclosure, a carrier may be replaced with at least one of a BWP and/or a resource pool, or vice versa. For example, a carrier may include at least one of a BWP and/or a resource pool. For example, a carrier may include one or more BWPs. For example, a BWP may include one or more resource pools.

In the present disclosure, for example, the definition, concept, content and/or function indicated by the term “transmission UE” may be the same as or similar to the definition, concept, content and/or function indicated by a TX UE, a transmitting apparatus, a transmitting UE, a transmitting UE, a transmitting UE, a first apparatus, a first UE, an apparatus, and the like.

In the present disclosure, for example, the definition, concept, content and/or function indicated by the term “receiving UE” may be the same as or similar to the definition, concept, content and/or function indicated by a RX UE, a receiving apparatus, a receiving UE, a second apparatus, a second UE, and the like.

In this disclosure, the “TX UE” wording may be interpreted as a UE performing data transmission (e.g., PSCCH/PSSCH) (to a (target) RX UE), and/or a UE performing transmission of SL CSI-RS (and/or SL CSI report request indicator) (to a (target) RX UE), and/or a UE performing transmission of a (predefined) RS (e.g., PSSCH DM-RS) (and/or SL (L1) RSRP report request indicator) to be used for SL (L1) RSRP measurement to a ((target) RX UE), and/or a UE transmitting (control) channel (e.g., PSCCH, PSSCH) to be used for operation of ((target) RX UE's) SL ratio link monitoring (RLM) (and/or SL radio link failure (RLF)) and/or a RS (e.g., DM-RS, CSI-RS) (on the (control) channel).

In the present disclosure, a transmitting UE may be a UE that transmits data (e.g., PSCCH and/or PSSCH) to a (target) receiving UE. Alternatively, a transmitting UE may be a UE performing transmission of a sidelink channel state information reference signal (SL CSI-RS) and/or a sidelink channel state information (SL CSI) report request indicator (or sidelink channel status information report request information) to a (target) receiving UE. Alternatively, a transmitting UE may be a UE performing transmission of a reference signal for sidelink RSRP (reference signal received power) measurement and/or a sidelink RSRP report request indicator (or sidelink RSRP report request information) to a (target) receiving UE. At this time, as an example, the sidelink RSRP may be an RSRP measurement value calculated using filtering of an L1 (layer-1) layer. For example, a reference signal for measuring a sidelink RSRP may be a predefined reference signal. As an example, a reference signal for measuring the RSRP may be a PSSCH DMRS (Demodulation Reference Signal), a DMRS for a PSSCH, or a DMRS related to a PSSCH. Alternatively, a transmitting UE may be a UE transmitting a channel for sidelink radio link monitoring (SL RLM) and/or sidelink radio link failure (SL RLF) operation of a (target) receiving UE. Alternatively, a transmitting UE may be a UE transmitting a reference signal (e.g., DMRS or CSI-RS) on a channel for SL RLM and/or SL RLF operation of a (target) receiving UE. In this case, as an example, the channel for the SL RLM and/or SL RLF operation of the receiving UE may be a PSCCH or a PSSCH.

In this disclosure, the “RX UE” wording may be interpreted as a UE transmitting SL HARQ feedback (to a TX UE) according to whether the decoding of a data received from the TX UE succeeds (and/or whether the detection/decoding of a (PSSCH scheduling related) PSCCH transmitted by the TX UE succeeds), and/or a UE performing SL CSI transmission (to a TX UE) based on the SL CSI-RS (and/or SL CSI report request indicator) received from the TX UE, and/or a UE transmitting (to a TX UE) SL (L1) RSRP measurement value based on a (pre-defined) RS (and/or SL (L1) RSRP report request indicator) received from the TX UE, and/or a UE performing its own data transmission (for a TX UE), and/or a UE performing RLM (and/or RLF) operation based on the (pre-configured) (control) channel and/or a RS (on the (control) channel) received from a TX UE

In the present disclosure, a receiving UE may be a UE that transmits SL HARQ feedback information (to a transmitting UE) according to whether the decoding of the data received from the transmitting UE succeeds in decoding and/or the detection/decoding success of a PSCCH (related to the scheduling of a PSSCH) transmitted by the transmitting UE. Alternatively, a receiving UE may be a UE that performs SL CSI transmission (to a transmitting UE) based on a SL CSI-RS and/or SL CSI report request indicator (or SL CSI report request information) received from the transmitting UE. Alternatively, a receiving UE may be a UE transmitting a sidelink RSRP measurement value (to a transmitting UE) based on a reference signal and/or sidelink RSRP report request indicator (or sidelink RSRP report request information) received from the transmitting UE. At this time, as an example, the sidelink RSRP may be an RSRP measurement value calculated using filtering of an L1 (layer-1) layer. Alternatively, a receiving UE may be a UE performing data transmission of the receiving UE (to a transmitting UE). As an example, a receiving UE may be a UE performing SL RLM and/or SL RLF operation based on a (pre-configured) channel received from a transmitting UE and/or a reference signal received on the channel. In this case, for example, the channel may be a control channel.

In this disclosure, a receiving UE may transmit (to a transmitting UE) at least one of sidelink HARQ feedback, SL CSI, and sidelink RSRP. In the present disclosure, a physical channel used when a receiving UE transmits at least one of sidelink HARQ feedback, sidelink CSI, or sidelink RSRP (to a transmitting UE) may be referred to as a PSFCH or a sidelink feedback channel. At this time, as an example, the sidelink RSRP may be an RSRP measurement value calculated using filtering of an L1 (layer-1) layer.

In one embodiment, when a RX UE transmits SL HARQ feedback information for a PSSCH (and/or PSCCH) received from a TX UE, the following (some) schemes (or OPTION: OPTION 1 or OPTION 2) may be considered. Here, as an example, the (some) scheme may be limitedly applied only when the RX UE successfully decodes/detects the PSCCH scheduling the PSSCH.

OPTION 1) NACK information is transmitted only when PSSCH decoding/reception fails

OPTION 2) ACK information is transmitted when PSSCH decoding/receiving is successful, and in case of failure, NACK information is transmitted.

As an example, through sidelink control information (SCI), the following (partial) information may be interpreted as being transmitted. For example, through SCI, at least one of resource allocation information related to PSSCH (and/or PSCCH) (e.g., location/the number of time/frequency resources, resource reservation information (e.g., period)), a request indicator of SL CSI report (or a request indicator of SL (L1) RSRP (and/or SL (L1) RSRQ and/or SL (L1) RSSI) report), SL CSI transmission indicator (on PSSCH) (or SL (L1) RSRP (and/or SL (L1) RSRQ and/or SL (L1) RSSI) information transmission indicator), MCS information, information related to TX power, information related to L1 destination ID and/or information related to L1 source ID, information related to SL HARQ process ID, information related to NDI, information related to RV, QoS information (related to transmission traffic/packet) (e.g., priority), SL CSI-RS transmission indicator (or information related to the number or SL CSI-RS antenna ports (which is transmitted)), location information related to a TX UE (or location (or distance area) information of a target RX UE (in which SL HARQ feedback is requested)) or information related to a reference signal (e.g., DM-RS) related to decoding data on PSSCH (and/or channel estimation) (e.g., DM-RS (time/frequency) pattern, RANK, antenna port index) may be transmitted.

In the present disclosure, the wording “PSCCH” may be extendedly interpreted as SCI (and/or first SCI (or second SCI)) (and/or “SCI” wording may be extendedly interpreted as PSCCH (and/or first SCI (or second SCI)) and/or “PSSCH” wording may be extendedly interpreted as second SCI)

Here, as an example, “first SCI” and “second SCI” refer to each when dividing the SCI configuration fields into two groups in consideration of the (relatively) high SCI payload size, in addition, first SCI and second SCI may be transmitted through different channels (for example, first SCI may be transmitted through PSCCH, and second SCI may be piggybacked on PSSCH and transmitted together with data (or transmitted through (independent) PSCCH).).

In this specification, a receiving UE may transmit (to a transmitting UE) at least one of sidelink HARQ feedback, SL CSI, and sidelink RSRP. In this specification, a physical channel used when a receiving UE transmits at least one of sidelink HARQ feedback, sidelink CSI, or sidelink RSRP (to the transmitting UE) may be referred to as a PSFCH or a sidelink feedback channel. At this time, as an example, a sidelink RSRP may be an RSRP measurement value calculated using filtering of an L1 (layer-1) layer.

In the disclosure, when a receiving UE transmits SL HARQ feedback information for a PSSCH and/or PSCCH received from a transmitting UE, at least one of the following schemes may be considered. Or, at least one of the schemes may be limitedly applied only when the receiving UE successfully decodes/detects the PSCCH scheduling the PSSCH.

Method A) a receiving UE may transmit NACK information only when the receiving UE fails at decoding and/or reception of PSSCH.

Method B) in case that a receiving UE succeeds at decoding and/or receiving of PSSCH, the receiving UE may transmit ACK information, and in case of failure, the receiving UE may transmit NACK information.

Meanwhile, a transmitting UE may transmit at least one of the following information to a receiving UE through sidelink control information (SCI).
PSSCH and/or PSCCH related resource allocation information. For example, it may be location of time-frequency resources allocated or scheduled for PSSCH and/or PSCCH transmission and/or the number of time-frequency resources allocated or scheduled for PSSCH and/or PSCCH transmission and/or information related to resource reservations (e.g., the cycle of resource reservations)
SL CSI report request indicator (or related information) and/or SL (L1) RSRP report request indicator (or related information) and/or SL (L1) reference signal received quality (RSRQ) report request indicator (or related information) and/or SL (L1) received signal strength indicator (RSSI) report request indicator (or related information). In this case, (L1) may mean that each of the SL RSRP, the SL RSRQ, and the SL RSSI is a measured value calculated using filtering of an L1 (layer-1) layer.
SL CSI transmission indicator (or related information) on a time-frequency resource region allocated or scheduled for PSSCH transmission and/or SL RSRP information transmission indicator (or related information) and/or SL RSRQ information transmission indicator (or related information) and/or SL RSSI information transmission indicator (or related information)
MCS information
transmission power information
L1 destination ID information and/or L1 source ID information
SL HARQ process ID information
new data indicator (NDI)
redundancy version (RV)
QoS information related to transport traffic and/or packets. For example, it may be information related to the priority of the transmission traffic and/or a packet.
SL CSI-RS transmission indicator (or related information) and/or information related to the number of (transmitted) SL CSI-RS antenna ports
location information of a transmitting UE and/or location information of a target receiving UE (where transmission of SL HARQ feedback information is requested) and/or information related to distance region of a target receiving UE (where transmission of SL HARQ feedback information is requested).
information related to a reference signal related to decoding (and/or demodulation and/or channel estimation) of a data transmitted through a PSSCH. For example, it may be information related to a time-frequency mapping pattern of the reference signal and/or rank (or layer) related information and/or information related to antenna port index. For example, the reference signal may be DMRS.

In this specification, the term expressed as PSCCH may be replaced with SCI. And/or, the term expressed as PSCCH may be replaced with first SCI or second SCI only when a transmitting UE transmits two-stage SCI to a receiving UE. And/or, the term expressed as SCI may be replaced with PSCCH. And/or, only when a transmitting UE transmits two-stage SCI to a receiving UE, the term expressed as SCI may be replaced with first SCI or second SCI. And/or, only when a transmitting UE transmits 2-stage SCI to a receiving UE and transmits second SCI through a PSSCH, the term expressed as PSSCH may be replaced with second SCI. For example, when dividing the entire SCI field information into two SCI field information groups (For example, the first SCI field information group and the second SCI field information group) in consideration of the (relatively) high SCI payload size, SCI including each SCI field information group may be referred to as the first SCI and the second SCI. For example, a transmitting UE may transmit the first SCI and the second SCI to a receiving UE through different channels. As a specific example, a transmitting UE transmits first SCI to a receiving UE through a PSCCH, may transmit second SCI to the receiving UE in a piggyback form together with data through a PSSCH. Alternatively, a transmitting UE may transmit first SCI to a receiving UE through a PSCCH, and may transmit second SCI to the receiving UE through an independent PSCCH.

In this disclosure, “configuration (or definition)” wording may be interpreted as being (pre)configured from a base station (or network) (through predefined signaling (e.g., SIB, MAC, RRC)). Also, as an example, in the present disclosure, the wording “RLF” may be extendedly interpreted as at least one of out of synch (OOS) and in synch (IS). As an example, in this disclosure, the wording “RB” may be extendedly interpreted as a subcarrier. Also, as an example, in the present disclosure, the wording “packet (or traffic)” may be extendedly interpreted as a transport block (TB) (or MAC PDU).

As an example, in the present disclosure, for convenience of description, the (physical) channel used when an RX UE transmits at least one of, for example, SL HARQ feedback, SL CSI, SL (L1) RSRP to a TX UE is named “physical sidelink feedback channel (PSFCH)”.

In this disclosure, the term expressed as “configuration” or “definition” may be interpreted as being (pre)configured or configured from a base station or a network (through predefined signaling (e.g., SIB, MAC, RRC)). For example, “A may be configured” may include “that a base station or network (pre)configures/defines or informs A for a UE”. Alternatively, a term expressed as “configuration” or “definition” may be interpreted as being configured or defined in advance by a system. For example, “A may be configured” may include “A is configured/defined in advance by a system”.

In the present disclosure, SL RLF may be determined based on at least one of OUT-OF-SYNCH (OOS or Out-of-Sync.) or IN-SYNCH (IS or In-Sync.).

In the present disclosure, a term expressed as a resource block (RB) may be replaced with a subcarrier.

In the present disclosure, a term expressed as a packet or traffic may be replaced with a transport block (TB) or a MAC PDU (Medium Access Control Protocol Data Unit) according to the communication layer.

As an example, when a UE performs TB transmission using resources on a plurality of slots, “Resource for retransmission (RETX_RSC)” may be protected from the viewpoint of transmission resource collision with other UEs, since a PSCCH (and/or PSSCH) (related to initial transmission) transmitted on the previous other slot signals “RETX_RSC-related resource allocation/scheduling information” (e.g., it is possible to exclude RETX_RSC (already occupied) based on PSCCH decoding and PSSCH DM-RS RSRP measurement). On the other hand, as an example, since there is no (separate) transmission before the “resource for initial transmission (INTX_RSC)”, it is difficult to enjoy the above effect. The following proposed method proposes a method for protecting INTX_RSC in terms of interference due to transmission resource collision. Here, as an example, it may be assumed that (independent) PSCCH/PSSCH transmission is performed on INTX_RSC (and/or RETX_RSC).

[Proposed Method #1] As an example, a TX UE may perform the following type of (predefined) channel (PRE_RSVSIG) transmission before INTX_RSC. Here, as an example, whether to allow transmission of PRE_RSVSIG may be differently designated/configured according to service type/priority (and/or requirement (e.g., priority, reliability, latency, min. required communication range, etc.)), cast type (e.g., unicast, groupcast, broadcast), congestion level or the like. Here, as an example, PRE_RSVSIG may be interpreted as a kind of preemption message.

OPTION A: PSCCH Only transmission

Here, as an example, the corresponding PSCCH transmission may be configured to (exceptionally) use the long format (e.g., a form of being transmitted using symbols other than all symbols (or some/specific symbols (e.g., the last symbol on the SLOT may be designated for TX-RX switching time) on the (pre-configured) slot).

OPTION B: Transmission of PSSCH and (Linked) PSCCH

As an example, the following (partial) information (for example, at least one of PRE_RSVSIG indicator, INTX_RSC resource allocation information, INTX_RSC based PSSCH transmission-related scheduling/HARQ information, QoS information related to a packet transmitted on INTX_RSC, identifier information of a transmitting UE performing a transmission based on INTX_RSC) may be included on the PRE_RSVSIG-related PSCCH (and/or PSSCH). Here, for example, the corresponding (partial) information (e.g., resource allocation information) on PSCCH, is generally “not for (simply) linked PSSCH” but for (following) INTX_RSC (and/or RETX_RSC). In other words, as an example, it may be interpreted as (help) information for the preemption operation (or sensing-based collision avoidance operation) of another UE, for INTX_RSC (and/or RETX_RSC). Here, as an example, the following (partial) information (e.g., resource allocation information) may be transmitted through second SCI (or first SCI) (e.g., when second SCI is transmitted through PSSCH, PSSCH DM-RS can be used for RSRP measurement for sensing/resource exclusion operation).

PRE_RSVSIG Indicator

Here, as an example, the corresponding indicator may be signaled by defining/adding a new field (e.g., 1 bit) on the existing SCI used for PSSCH scheduling. As a specific example, if the corresponding field is designated as “1”, the (part of, or all of) existing SCI field may be reinterpreted, and may be considered as (part of below) information for INTX_RSC (and/or RETX_RSC). (for example, if the relevant field is specified as “0”, it is interpreted as an existing SCI)
INTX_RSC (and/or RETX_RSC) related (PSCCH/PSSCH) resource allocation information (e.g., the number/location of time/frequency resources, resource reservation period, etc.)

Here, as an example, a granularity (e.g., the basic unit size of time/frequency resources used for scheduling) related to the resource allocation information is configured differently from the existing SCI. (e.g., it can be specified to use a relatively large sized base unit, which can reduce the payload size)
INTX_RSC (and/or RETX_RSC) based PSSCH (and/or PSCCH) transmission related scheduling/HARQ information (e.g., MCS, rank, antenna port index, RV, NDI, HARQ process ID, etc.)
QoS information related to a packet transmitted on INTX_RSC (and/or RETX_RSC) (e.g., priority, reliability, latency, minimum required communication range, etc.)
identifier information of a transmitting UE performing transmission based on INTX_RSC (and/or RETX_RSC) (e.g., (L1 or L2) source ID) (and/or identifier information of the target UE of the transmission (e.g., (L1 or L2) destination ID))

[Proposed Method #2] As an example, when [Proposed Method #1] is applied, option A and/or option B related PSCCH (and/or PSSCH) transmission may be performed based on a preconfigured (time/frequency) resource size (e.g., one subchannel).

Here, as an example, in the case of option B, through the PSSCH, (preconfigured) dummy information/packet (e.g., it can be interpreted as a type of PSSCH transmission without MAC PDU) may be transmitted, or some (preconfigured) information related to a packet to be transmitted on INTX_RSC (and/or RETX_RSC) may be transmitted.

[Proposed Method #3] As an example, when [Proposed Method #1] is applied, a UE may be caused to perform sensing/resource exclusion operation for INTX_RSC (and/or RETX_RSC) as per (some) rules/assumptions below.

For example, it is considered that a DM-RS RSRP (or RSSI) measurement value (e.g., when option A and/or option B is applied) (and/or DM-RS RSRP (or RSSI) measurement value for PRE_RSVSIG-related PSSCH (e.g., when OPTION B is applied)) for the PRE_RSVSIG related PSCCH is valid (or equally applied) on INTX_RSC (and/or RETX_RSC).

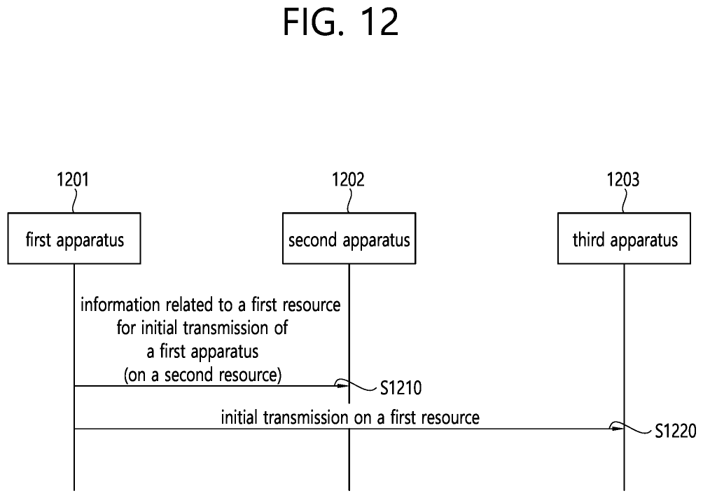

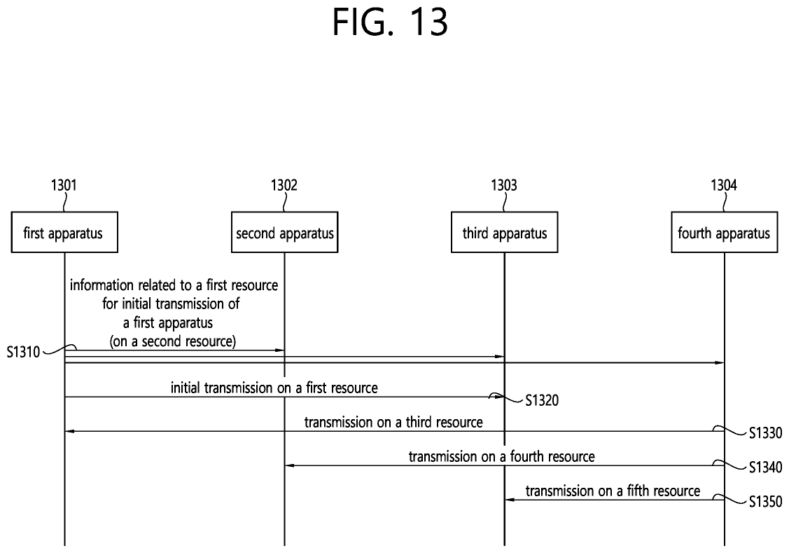

In FIG. 12 and FIG. 13 below, with respect to at least one of the above-mentioned [Proposed Method #1], [Proposed Method #2] or [Proposed Method #3], examples (embodiments) in which sidelink communication is performed between apparatuses based on information related to resources for initial transmission will be reviewed.

FIG. 12 shows an example in which sidelink communication is performed between apparatuses based on information related to resources for initial transmission, FIG. 13 shows another example in which sidelink communication is performed between apparatuses based on information related to resources for initial transmission.

Referring to FIG. 12, in step S1210, a first apparatus 1201 according to an embodiment may transmit information related to a first resource for initial transmission of the first apparatus 1201 to a second apparatus 1202. The information related to the first resource may be transmitted from the first apparatus 1201 to the second apparatus 1202 on a second resource that precedes the first resource in time.

In one example, a transmission of information related to the first resource from the first apparatus 1201 to the second apparatus 1202 may be unicast transmission based on a unicast connection between the first apparatus 1201 and the second apparatus 1202. In another example, a transmission of information related to the first resource from the first apparatus 1201 to the second apparatus 1202 may be one of groupcast transmissions transmitted by the first apparatus 1201 to a plurality of receiving apparatuses. In another example, the information related to the first resource may be transmitted from the first apparatus 1201 to the second apparatus 1202 and the third apparatus 1203.

In step S1220, a first apparatus 1201 according to an embodiment may perform initial transmission to the third apparatus 1203 on a first resource.

Referring to FIG. 13, in step S1310, a first apparatus 1301 according to an embodiment may transmit information related to a first resource for initial transmission of the first apparatus 1301 to one of a second apparatus 1302, a third apparatus 1303 or the fourth apparatus 1304. In FIG. 13, it is indicated as if the information related to the first resource is indicated as being transmitted from the first apparatus 1301 to the second apparatus 1302, the third apparatus 1303, and the fourth apparatus 1304, a person skilled in the art will easily understand that the information related to the first resource may be transmitted from the first apparatus 1301 to at least one of the second apparatus 1302, the third apparatus 1303, or the fourth apparatus 1304. For example, the information related to the first resource may be transmitted to the second apparatus 1302 and the fourth apparatus 1304 except for the third apparatus 1303. The information related to the first resource may be transmitted from the first apparatus 1301 to at least one of the second apparatus 1302, the third apparatus 1303, or the fourth apparatus 1304 based on groupcast communication or unicast communication.

In one example, on a second resource that precedes the first resource in time, the information related to the first resource may be transmitted from the first apparatus 1301 to at least one of the second apparatus 1302, the third apparatus 1303, or the fourth apparatus 1304.

In step S1320, a first apparatus 1301 according to an embodiment may perform initial transmission to the third apparatus 1303 on a first resource.

In step S1330, a fourth apparatus 1304 according to an embodiment may perform initial transmission (or transmit data or control information) to a first apparatus 1301 on a third resource. In step S1340, a fourth apparatus 1304 according to an embodiment may perform initial transmission (or transmit data or control information) to a second apparatus 1302 on a fourth resource. In step S1350, a fourth apparatus 1304 according to an embodiment may perform initial transmission (or transmit data or control information) to a third apparatus 1303 on a fifth resource.

In one example, the third resource, the fourth resource, and the fifth resource may be different from the first resource. That is, the third resource, the fourth resource, and the fifth resource may not have a resource region overlapping with the first resource.

In one embodiment, a fourth resource that the second apparatus 1302 senses to receive the (initial) transmission of the fourth apparatus 1304 from the fourth apparatus 1304 may not include the first resource.

Hereinafter, some embodiments that may be applied to FIGS. 12 and/or 13 will be described.

In case that a transmitting UE performs transmission of a transport block (TB) in a first slot resource included in a plurality of slots, through a PSCCH and/or PSSCH allocated or scheduled for an initial TB transmission, the transmitting UE may transmit information related to allocation or scheduling of a resource (RETX_RSC) for TB retransmission of the transmitting UE to a receiving UE in another second slot resource before the first slot resource. In this case, the RETX_RSC may be protected without colliding with transmission resources of other UEs. For example, based on decoding of a PSCCH received from a transmitting UE and a RSRP measurement based on a PSSCH DMRS received from the transmitting UE, a receiving UE may not use RETX_RSC (already occupied) by the transmitting UE when performing transmission. Or, based on decoding of a PSCCH received from a transmitting UE and a RSRP measurement based on a PSSCH DMRS received from a transmitting UE, a receiving UE may exclude RETX_RSC when determining or selecting a transmission resource. Or, based on decoding of a PSCCH received from a transmitting UE and a RSRP measurement based on a PSSCH DMRS received from the transmitting UE, a receiving UE may exclude RETX_RSC when sensing the transmission resource.

On the other hand, because there is no transmission on the prior slot resource, the resource (INTX_RSC) for initial TB transmission may have little effect due to occupation by a transmitting UE, that is, it is difficult to be protected from collision with the transmission resources of other UEs.

In order to solve the above problems, according to an embodiment of the present disclosure below, a method for a sidelink UE to reserve an initial TB transmission resource in an NR V2X system and an apparatus supporting the same are proposed. Here, for example, in INTX_RSC and/or RETX_RSC, transmission of the (independent) PSCCH and/or PSSCH of a transmitting UE may be performed.

According to an embodiment of the present disclosure, a transmitting UE may transmit PRE_RSVSIG to a receiving UE through a channel according to at least one of the following methods (method A and method B) (predefined) in the time resource before INTX_RSC. Here, whether to allow the transmission UE to transmit PRE_RSVSIG may be differently designated or configured according to service type and/or service priority and/or service requirement and/or cast type and/or congestion level, etc. For example, the service requirements may include priority, reliability, latency, and minimum required communication range. For example, the cast type may be one of unicast, groupcast, and broadcast. Here, PRE_RSVSIG may be in the form of a kind of preemption message.
Scheme A: a transmitting UE may transmit only the PSCCH to a receiving UE. Here, as an example, the corresponding PSCCH transmission may be (exceptionally) configured to use the long format (a form where it is transmitted using all symbols (or some/specific symbols (e.g., the last symbol on the slot may be designated for TX-RX switching time)) on (preconfigured) slot).
Scheme B: a transmitting UE may transmit a PSCCH and a PSCCH (related to the PSCCH) to a receiving UE.

According to an embodiment of the present disclosure, at least one of the following information may be included and transmitted to a receiving UE through a PSCCH and/or a PSSCH related to PRE_RSVSIG transmitted by a transmitting UE. Here, the at least one piece of information (e.g., resource allocation related information) transmitted to a receiving UE through a PSCCH is generally not simply associated PSSCH-related information, but may be information for subsequent INTX_RSC and/or RETX_RSC. Alternatively, the at least one piece of information (e.g., resource allocation related information (INTX_RSC and/or RETX_RSC)) transmitted to a receiving UE through a PSCCH may be help information for another UE to perform an operation for resource preemption or a resource sensing-based collision avoidance operation. Here, when a transmitting UE transmits the 2-stage SCI to a receiving UE, the at least one piece of information may be field information of first SCI or field information of second SCI. For example, in case that a transmitting UE transmits second SCI to a receiving UE through a PSSCH, the receiving UE may sense a transmission resource using the PSSCH DMRS, or perform RSRP measurement for excluding INTX_RSC and/or RETX_RSC when determining or selecting.
PRE_RSVSIG directive (or related information). Here, the PRE_RSVSIG indicator (or related information) may be transmitted by additionally including a new information field (e.g., 1 bit) in the existing SCI used for PSSCH scheduling. Specifically, for example, when the new information field is designated as “1” or indicates “1”, a receiving UE may interpret some or all of the existing SCI information field as INTX_RSC (and/or RETX_RSC) related information. For example, when the new information field is designated as “0” or indicates “0”, a receiving UE may interpret the existing SCI information field as it is.
INTX_RSC (and/or RETX_RSC) related PSSCH resource allocation information and/or INTX_RSC (and/or RETX_RSC) related PSCCH resource allocation information. For example, it may be information such as the number of time-frequency resources and/or location of time-frequency resources, a resource reservation period, and the like. Here, a granularity related to the resource allocation information may be configured differently from the existing SCI. For example, the granularity related to the resource allocation information may be a basic unit size of a time-frequency resource used for scheduling. For example, the granularity related to the resource allocation information may be designated to use a relatively large basic unit, in this way, a size of a payload can be reduced.
INTX_RSC (and/or RETX_RSC) based PSSCH scheduling/HARQ related information and/or INTX_RSC (and/or RETX_RSC) based PSCCH scheduling/HARQ related information. For example, it may be MCS information rank (or layer) information, antenna port index, RV, NDI, HARQ Process ID, and the like.
QoS related information related to a packet transmitted on INTX_RSC (and/or RETX_RSC). For example, it may be priority, reliability, delay, minimum required communication range, and the like.
identifier information of a transmitting UE performing INTX_RSC (and/or RETX_RSC)-based transmission and/or identifier information of a target receiving UE for the INTX_RSC (and/or RETX_RSC)-based transmission. For example, the identifier information of a transmitting UE performing the INTX_RSC (and/or RETX_RSC)-based transmission may be a (L1 or L2) source ID. For example, the identifier information of a target receiving UE for the INTX_RSC (and/or RETX_RSC)-based transmission may be a (L1 or L2) destination ID.

According to another embodiment of the present disclosure, in the one embodiment or a combination of the embodiments, a transmitting UE may transmit a PSCCH related to the method A to a receiving UE based on the size of a preconfigured time-frequency resource. Alternatively, in the above embodiments or a combination of embodiments, a transmitting UE may transmit a PSCCH and/or PSSCH related to the method B to a receiving UE based on a preconfigured time-frequency resource size. For example, the size of the preconfigured time-frequency resource may be one subchannel. Here, when a transmitting UE transmits a PSSCH to a receiving UE according to the method B, the transmitting UE may transmit (pre-configured) dummy information and/or packets through the PSSCH. For example, dummy information may be transmitted through a PSSCH that does not include a MAC PDU. Or, when a transmitting UE transmits a PSSCH to a receiving UE according to the method B, the transmitting UE may transmit some (pre-configured) information related to packets to be transmitted in INTX_RSC and/or RETX_RSC through the PSSCH.

According to another embodiment of the present disclosure, in the above embodiments or a combination of embodiments, a receiving UE may not use INTX_RSC and/or RETX_RSC according to at least one of the following rules/assumptions when performing transmission. Alternatively, the receiving UE may exclude INTX_RSC and/or RETX_RSC according to at least one of the following rules/assumptions when sensing, determining, or selecting a transmission resource.
When a transmitting UE transmits a PRE_RSVSIG related PSCCH to a receiving UE according to the method A and/or the B, the receiving UE considers or determines a RSRP measurement value (or RSSI measurement value) based on PSCCH DMRS received from the transmitting UE as a valid value also in INTX_RSC and/or RETX_RSC.
When a transmitting UE transmits a PRE_RSVSIG related PSSCH to a receiving UE according to the method B, the receiving UE considers or determines the RSRP measurement value (or RSSI measurement value) based on the PRE_RSVSIG related PSSCH DMRS received from the transmitting UE as a valid value also in INTX_RSC and/or RETX_RSC.

The embodiments described herein may be combined with each other.

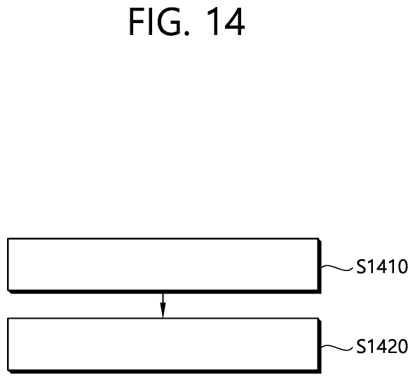

FIG. 14 is a flowchart showing an operation of a first apparatus according to an embodiment of the present disclosure.

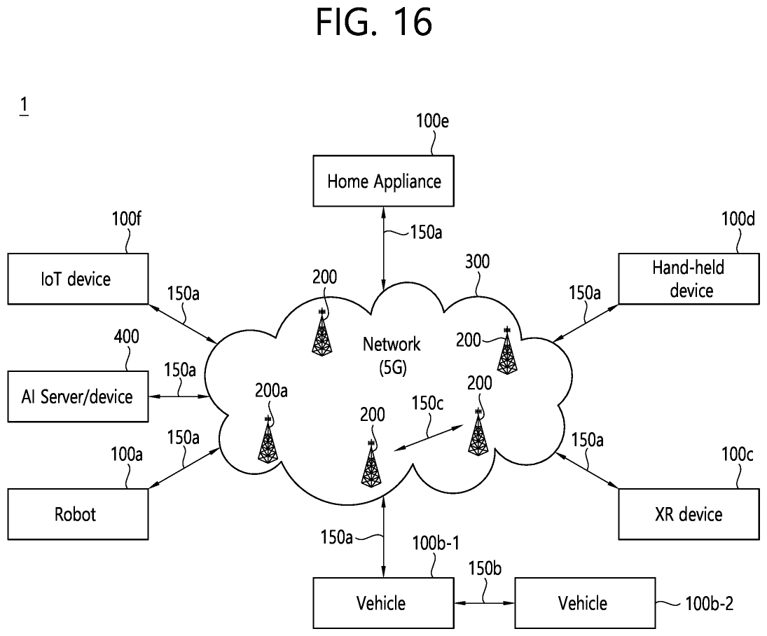

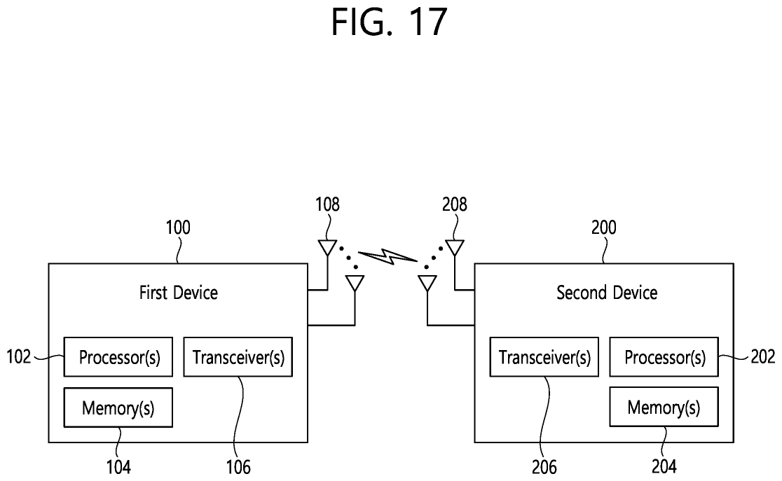

The operations disclosed in the flowchart of FIG. 14 may be performed in combination with various embodiments of the present disclosure. In one example, the operations disclosed in the flowchart of FIG. 14 may be performed based on at least one of the apparatuses illustrated in FIGS. 16 to 21. In one example, the first apparatus of FIG. 14 may correspond to the first wireless apparatus 100 of FIG. 17 to be described later. In another example, the first apparatus of FIG. 14 may correspond to the second wireless apparatus 200 of FIG. 17 to be described later.

In step S1410, a first apparatus according to an embodiment may transmit information related to a first resource for initial transmission of the first apparatus to a second apparatus. In one example, the first resource for the initial transmission may be denoted as INTX_RSC. In one example, information related to (transmission of) the first resource may be expressed as PRE_RSVSIG.

In step S1420, a first apparatus according to an embodiment may perform the initial transmission to a third apparatus on the first resource.

For an example, the information related to the first resource may be transmitted to the second apparatus on a second resource that precedes the first resource in time.

For an example, the initial transmission may be performed through at least one of a physical sidelink control channel (PSCCH) or a physical sidelink shared channel (PSSCH) for the initial transmission.

For an example, a third resource sensed by the second apparatus to receive a PSSCH or a PSCCH for the third apparatus or a fourth apparatus from the third apparatus or the fourth apparatus may not include the first resource.

For an example, the information related to the first resource may be transmitted on the second resource through a PSCCH related to the second resource.

For an example, first sidelink control information (SCI) may be transmitted through the PSCCH, the first SCI may include an indicator field representing whether the first SCI includes the information related to the first resource.

For an example, a size of the indicator field may be 1 bit, and based on a value of the indicator field is 1, the first SCI may include the information related to the first resource.

For an example, information related to the first resource may be transmitted on the second resource through a PSCCH related to the second resource and a PSSCH related to the PSCCH.

For an example, a first SCI may be transmitted through the PSCCH, a second SCI may be transmitted through the PSSCH, and the information related to the first resource may be included in the first SCI or the second SCI.

For an example, the first SCI or the second SCI may include an indicator field representing whether the first SCI includes the information related to the first resource.

For an example, a size of the indicator field may be 1 bit, and based on a value of the indicator field is 1, the first SCI may include the information related to the first resource.

For an example, whether to allow transmission of the information related to the first resource may be determined based on at least one of service type, priority, reliability requirement, delay requirement, minimum coverage requirement, cast type or congestion level.

For an example, the information related to the first resource may include resource allocation information of at least one of the PSCCH and the PSSCH for the initial transmission. The resource allocation information may include at least one of the number of time resources, location of a time resource, the number of frequency resources, location of a frequency resource or a period of resource reservation.

For an example, the information related to the first resource may include at least one of scheduling information or hybrid automatic repeat request (HARQ) information related to transmission of the PSSCH related to the initial transmission.

For an example, the information related to the first resource may include quality of service (QoS) information related to a packet on the initial transmission. The information related to the first resource may include priority, reliability, latency, minimum required communication range, etc. related to a packet on the initial transmission.

For an example, the information related to the first resource may include a source identifier (ID) of the first apparatus.

According to an embodiment of the present disclosure, a first apparatus for performing sidelink (SL) communication may be proposed. The first apparatus may comprise: one or more memories storing instructions; one or more transceivers; and one or more processors connected to the one or more memories and the one or more transceivers, wherein the one or more processors execute the instructions to: control the one or more transceivers to transmit information related to a first resource for initial transmission of the first apparatus to a second apparatus; and control the one or more transceivers to perform the initial transmission to a third apparatus on the first resource, wherein the information related to the first resource is transmitted to the second apparatus on a second resource that precedes the first resource in time.

According to an embodiment of the present disclosure, an apparatus configured to control a first user equipment (UE) may be proposed. The apparatus may comprise: one or more processors; and one or more memories operably connectable to the one or more processors and storing instructions, wherein the one or more processors execute the instructions to: transmit information related to a first resource for initial transmission of a first UE to a second UE; and perform the initial transmission to a third UE on the first resource, wherein the information related to the first resource is transmitted to the second UE on a second resource that precedes the first resource in time.

For an example, in one example, the first UE of the embodiment may refer to the first apparatus described in the first half of the present disclosure. In one example, the at least one processor, the at least one memory, etc. in the apparatus for controlling the first UE may be implemented as separate sub-chips, or at least two or more components may be implemented through one sub-chip.

According to an embodiment of the present disclosure, a non-transitory computer-readable storage medium storing instructions may be proposed. The instructions, when executed, may cause a first apparatus to: transmit information related to a first resource for initial transmission of the first apparatus to a second apparatus; and perform the initial transmission to a third apparatus on the first resource, wherein the information related to the first resource is transmitted to the second apparatus on a second resource that precedes the first resource in time.

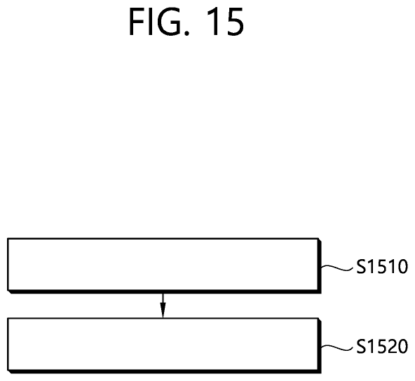

FIG. 15 is a flowchart showing an operation of a second apparatus according to an embodiment of the present disclosure.

The operations disclosed in the flowchart of FIG. 15 may be performed in combination with various embodiments of the present disclosure. In one example, the operations disclosed in the flowchart of FIG. 15 may be performed based on at least one of the apparatuses illustrated in FIGS. 16 to 21. In one example, the second apparatus of FIG. 15 may correspond to the second wireless apparatus 200 of FIG. 17 to be described later. In another example, the second apparatus of FIG. 15 may correspond to the first wireless apparatus 100 of FIG. 17 to be described later.

In step S1510, a second apparatus according to an embodiment may receive information related to a first resource for initial transmission of a first apparatus, transmitted from the first apparatus.

In step S1520, a second apparatus according to an embodiment may perform SL communication based on the information related to the first resource.

In one example, the information related to the first resource may be transmitted from the first apparatus on a second resource that precedes the first resource in time.

In one example, performing the SL communication based on the information related to the first resource may include: determining a third resource to transmit SL data based on the information related to the first resource; and transmitting the SL data on the third resource. In this case, the third resource may not include the first resource. That is, the third resource may not overlap the first resource.

In one example, the initial transmission by the first apparatus may be performed through at least one of a physical sidelink control channel (PSCCH) or a physical sidelink shared channel (PSSCH) for the initial transmission.

For an example, a third resource sensed by the second apparatus to receive a PSSCH or a PSCCH for the third apparatus or a fourth apparatus from the third apparatus or the fourth apparatus may not include the first resource.

For an example, the information related to the first resource may be transmitted on the second resource through a PSCCH related to the second resource.

For an example, first sidelink control information (SCI) may be transmitted through the PSCCH, the first SCI may include an indicator field representing whether the first SCI includes the information related to the first resource.

For an example, a size of the indicator field may be 1 bit, and based on a value of the indicator field is 1, the first SCI may include the information related to the first resource.

For an example, information related to the first resource may be transmitted on the second resource through a PSCCH related to the second resource and a PSSCH related to the PSCCH.

For an example, a first SCI may be transmitted through the PSCCH, a second SCI may be transmitted through the PSSCH, and the information related to the first resource may be included in the first SCI or the second SCI.

For an example, the first SCI or the second SCI may include an indicator field representing whether the first SCI includes the information related to the first resource.

For an example, a size of the indicator field may be 1 bit, and based on a value of the indicator field is 1, the first SCI may include the information related to the first resource.

For an example, whether to allow transmission of the information related to the first resource may be determined based on at least one of service type, priority, reliability requirement, delay requirement, minimum coverage requirement, cast type or congestion level.

For an example, the information related to the first resource may include resource allocation information of at least one of the PSCCH and the PSSCH for the initial transmission. The resource allocation information may include at least one of the number of time resources, location of a time resource, the number of frequency resources, location of a frequency resource or a period of resource reservation.

For an example, the information related to the first resource may include at least one of scheduling information or hybrid automatic repeat request (HARQ) information related to transmission of the PSSCH related to the initial transmission.

For an example, the information related to the first resource may include quality of service (QoS) information related to a packet on the initial transmission. The information related to the first resource may include priority, reliability, latency, minimum required communication range, etc. related to a packet on the initial transmission.

For an example, the information related to the first resource may include a source identifier (ID) of the first apparatus.

According to an embodiment of the present disclosure, a second apparatus for performing sidelink (SL) communication may be proposed. The second apparatus may comprise: one or more memories storing instructions; one or more transceivers; and one or more processors connected to the one or more memories and the one or more transceivers, wherein the one or more processors execute the instructions to: control the one or more transceivers to receive information related to a first resource for initial transmission of a first apparatus, transmitted from the first apparatus; and perform SL communication based on the information related to the first resource, wherein the information related to the first resource is transmitted from the first apparatus on a second resource that precedes the first resource in time.

Various embodiments of the present disclosure may be independently implemented. Alternatively, the various embodiments of the present disclosure may be implemented by being combined or merged. For example, although the various embodiments of the present disclosure have been described based on the 3GPP LTE system for convenience of explanation, the various embodiments of the present disclosure may also be extendedly applied to another system other than the 3GPP LTE system. For example, the various embodiments of the present disclosure may also be used in an uplink or downlink case without being limited only to direct communication between UEs. In this case, a base station, a relay node, or the like may use the proposed method according to various embodiments of the present disclosure. For example, it may be defined that information on whether to apply the method according to various embodiments of the present disclosure is reported by the base station to the UE or by a transmitting UE to a receiving UE through pre-defined signaling (e.g., physical layer signaling or higher layer signaling). For example, it may be defined that information on a rule according to various embodiments of the present disclosure is reported by the base station to the UE or by a transmitting UE to a receiving UE through pre-defined signaling (e.g., physical layer signaling or higher layer signaling). For example, some embodiments among various embodiments of the present disclosure may be applied limitedly only to a resource allocation mode 1. For example, some embodiments among various embodiments of the present disclosure may be applied limitedly only to a resource allocation mode 2.

Hereinafter, device(s) to which various embodiments of the present disclosure can be applied will be described.

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

FIG. 16 shows a communication system 1, based on an embodiment of the present disclosure.

Referring to FIG. 16, a communication system 1 to which various embodiments of the present disclosure are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g., relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

FIG. 17 shows wireless devices, based on an embodiment of the present disclosure.

Referring to FIG. 17, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 16.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

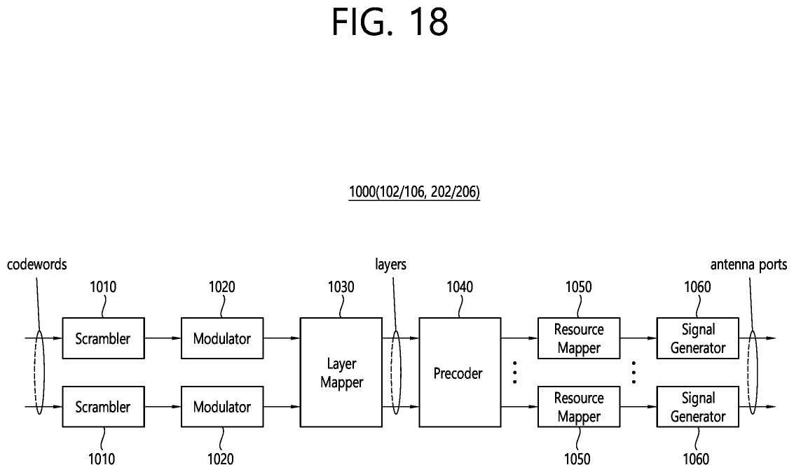

FIG. 18 shows a signal process circuit for a transmission signal, based on an embodiment of the present disclosure.

Referring to FIG. 18, a signal processing circuit 1000 may include scramblers 1010, modulators 1020, a layer mapper 1030, a precoder 1040, resource mappers 1050, and signal generators 1060. An operation/function of FIG. 18 may be performed, without being limited to, the processors 102 and 202 and/or the transceivers 106 and 206 of FIG. 17. Hardware elements of FIG. 18 may be implemented by the processors 102 and 202 and/or the transceivers 106 and 206 of FIG. 17. For example, blocks 1010 to 1060 may be implemented by the processors 102 and 202 of FIG. 17. Alternatively, the blocks 1010 to 1050 may be implemented by the processors 102 and 202 of FIG. 17 and the block 1060 may be implemented by the transceivers 106 and 206 of FIG. 17.

Codewords may be converted into radio signals via the signal processing circuit 1000 of FIG. 18. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 1010 to 1060 of FIG. 18. For example, the wireless devices (e.g., 100 and 200 of FIG. 17) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

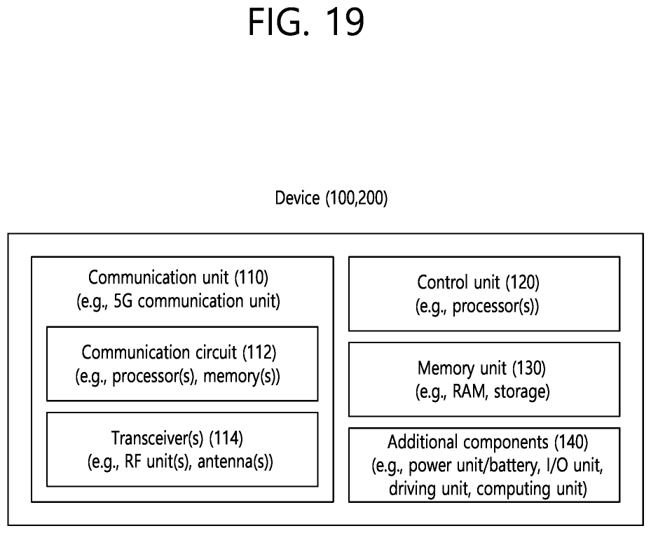

FIG. 19 shows another example of a wireless device, based on an embodiment of the present disclosure. The wireless device may be implemented in various forms according to a use-case/service (refer to FIG. 16).

Referring to FIG. 19, wireless devices 100 and 200 may correspond to the wireless devices 100 and 200 of FIG. 17 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 17. For example, the transceiver(s) 114 may include the one or more transceivers 106 and 206 and/or the one or more antennas 108 and 208 of FIG. 17. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 16), the vehicles (100b-1 and 100b-2 of FIG. 16), the XR device (100c of FIG. 16), the hand-held device (100d of FIG. 16), the home appliance (100e of FIG. 16), the IoT device (100f of FIG. 16), a digital broadcast terminal, a hologram device, a public safety device, an MTC device, a medicine device, a fintech device (or a finance device), a security device, a climate/environment device, the AI server/device (400 of FIG. 16), the BSs (200 of FIG. 16), a network node, etc. The wireless device may be used in a mobile or fixed place according to a use-example/service.

In FIG. 19, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 19 will be described in detail with reference to the drawings.

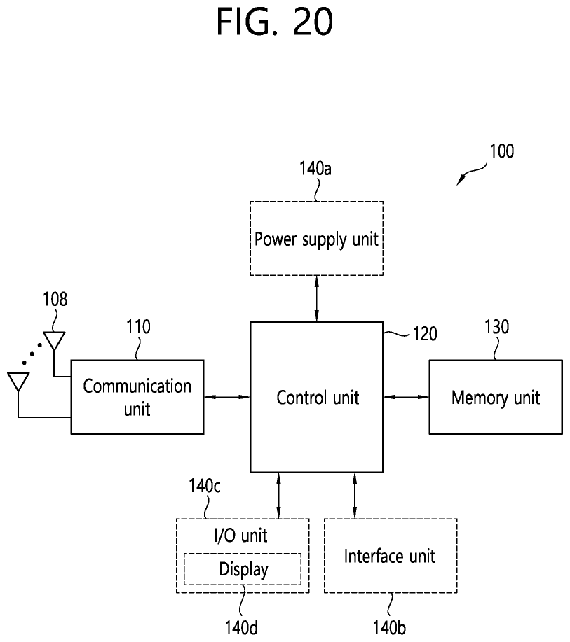

FIG. 20 shows a hand-held device, based on an embodiment of the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 20, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 19, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

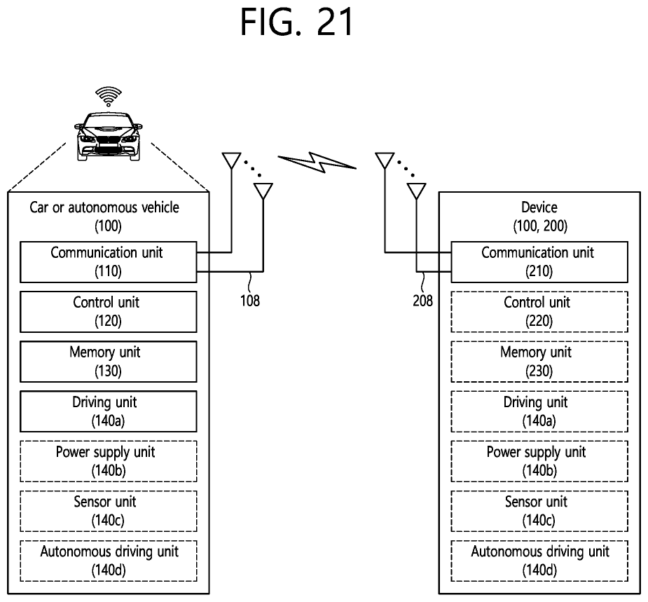

FIG. 21 shows a vehicle or an autonomous vehicle, based on an embodiment of the present disclosure. The vehicle or autonomous vehicle may be implemented by a mobile robot, a car, a train, a manned/unmanned Aerial Vehicle (AV), a ship, etc.

Referring to FIG. 21, a vehicle or autonomous vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 19, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous vehicle 100. The control unit 120 may include an Electronic Control Unit (ECU). The driving unit 140a may cause the vehicle or the autonomous vehicle 100 to drive on a road. The driving unit 140a may include an engine, a motor, a powertrain, a wheel, a brake, a steering device, etc. The power supply unit 140b may supply power to the vehicle or the autonomous vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous vehicles and provide the predicted traffic information data to the vehicles or the autonomous vehicles.

The scope of the disclosure may be represented by the following claims, and it should be construed that all changes or modifications derived from the meaning and scope of the claims and their equivalents may be included in the scope of the disclosure.

Claims in the present description can be combined in a various way. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method.

1. A method for performing, by a first apparatus, sidelink (SL) communication, the method comprising:
transmitting information related to a first resource for initial transmission of the first apparatus to a second apparatus; and
performing the initial transmission to a third apparatus on the first resource, wherein the information related to the first resource is transmitted to the second apparatus on a second resource that precedes the first resource in time.

2. The method of claim 1, wherein the initial transmission is performed through at least one of a physical sidelink control channel (PSCCH) or a physical sidelink shared channel (PSSCH) for the initial transmission.

3. The method of claim 2, wherein a third resource sensed by the second apparatus to receive a PSSCH or a PSCCH for the third apparatus or a fourth apparatus from the third apparatus or the fourth apparatus doesn't include the first resource.

4. The method of claim 1, wherein the information related to the first resource is transmitted on the second resource through a PSCCH related to the second resource.

5. The method of claim 4, wherein first sidelink control information (SCI) is transmitted through the PSCCH,
wherein the first SCI includes an indicator field representing whether the first SCI includes the information related to the first resource.

6. The method of claim 5, wherein a size of the indicator field is 1 bit, and
wherein based on a value of the indicator field is 1, the first SCI includes the information related to the first resource.

7. The method of claim 1, wherein the information related to the first resource is transmitted on the second resource through a PSCCH related to the second resource and a PSSCH related to the PSCCH.

8. The method of claim 7, wherein a first SCI is transmitted through the PSCCH,
wherein a second SCI is transmitted through the PSSCH, and
wherein the information related to the first resource is included in the first SCI or the second SCI.

9. The method of claim 1, wherein whether to allow transmission of the information related to the first resource is determined based on at least one of service type, priority, reliability requirement, delay requirement, minimum coverage requirement, cast type or congestion level.

10. The method of claim 2, wherein the information related to the first resource includes resource allocation information of at least one of the PSCCH and the PSSCH for the initial transmission,
wherein the resource allocation information includes at least one of the number of time resources, location of a time resource, the number of frequency resources, location of a frequency resource or a period of resource reservation.

11. The method of claim 2, wherein the information related to the first resource includes at least one of scheduling information or hybrid automatic repeat request (HARQ) information related to transmission of the PSSCH related to the initial transmission.

12. The method of claim 1, wherein the information related to the first resource includes quality of service (QoS) information related to a packet on the initial transmission.

13. The method of claim 1, wherein the information related to the first resource includes a source identifier (ID) of the first apparatus.

14. A first apparatus for performing sidelink (SL) communication, the first apparatus comprising:
one or more memories storing instructions;
one or more transceivers; and
one or more processors connected to the one or more memories and the one or more transceivers, wherein the one or more processors execute the instructions to:
control the one or more transceivers to transmit information related to a first resource for initial transmission of the first apparatus to a second apparatus; and
control the one or more transceivers to perform the initial transmission to a third apparatus on the first resource,
wherein the information related to the first resource is transmitted to the second apparatus on a second resource that precedes the first resource in time.

15. An apparatus configured to control a first user equipment (UE), the apparatus comprising:
one or more processors; and
one or more memories operably connectable to the one or more processors and storing instructions, wherein the one or more processors execute the instructions to:
transmit information related to a first resource for initial transmission of a first UE to a second UE; and
perform the initial transmission to a third UE on the first resource,
wherein the information related to the first resource is transmitted to the second UE on a second resource that precedes the first resource in time.

16-20. (canceled)
